(19) United States
(12) Patent Application Publication
(10) Pub. No.: US 2020/0341833 A1
(43) Pub. Date: Oct. 29, 2020

(54) PROCESSES AND SYSTEMS THAT DETERMINE ABNORMAL STATES OF SYSTEMS OF A DISTRIBUTED COMPUTING SYSTEM

(71) Applicant: VMware, Inc., Palo Alto, CA (US)

(72) Inventors: Arnak Poghosyan, Yerevan (AM); Ashot Nshan Harutyunyan, Yerevan (AM); Naira Movses Grigoryan, Yerevan (AM)

(73) Assignee: VMware, Inc., Palo Alto, CA (US)

(21) Appl. No.: 16/391,746

(22) Filed: Apr. 23, 2019

(51) Int. Cl. G06F 11/07; G06F 11/32; G06K 9/62; G06F 17/16

(52) U.S. Cl. CPC G06F 11/0793; G06F 11/327; G06N 5/04; G06F 17/16; G06K 9/6267

(57) ABSTRACT

Automated processes and systems that detect abnormal performance of a complex computational system of a distributed computing system are described. The processes and systems determine time stamps of previous abnormal behavior of the complex computational system and determine uncorrelated metrics associated with the complex computational system. Rules are determined based on the uncorrelated metrics and the time stamps of previous abnormal behavior of the complex computational system. Each rule may be applied to run-time metric values of the uncorrelated metrics to detect abnormal behavior of the complex computational system and generate a corresponding alert in approximate real time. Each rule may include displaying a recommendation for addressing the abnormality based on remedial measures used to correct the same abnormality in the past. Each rule may also automatically trigger remedial action that automatically corrects the abnormality.

### TECHNICAL FIELD

This disclosure is directed to processes and systems that detect abnormal behavior of systems of a distributed computing system.

### BACKGROUND

Electronic computing has evolved from primitive, vacuum-tube-based computer systems, initially developed during the 1940s, to modern electronic computing systems in which large numbers of multi-processor computer systems, such as server computers, work stations, and other individual computing systems are networked together with large-capacity data-storage devices and other electronic devices to produce geographically distributed computing systems with numerous components that provide enormous computational bandwidths and data-storage capacities. These large, distributed computing systems are made possible by advances in computer networking, distributed operating systems and applications, data-storage appliances, computer hardware, and software technologies.

Because distributed computing systems have an enormous number of computational resources, various management systems have been developed to collect performance information about the resources. For example, a typical management system may collect hundreds of thousands, or millions, of streams of metric data, called “metrics,” that are used to evaluate the performance of a data center infrastructure. Each metric value of a metric may represent an amount of a resource in use at a point in time. The metrics contain information that potentially may be used to determine performance abnormalities within the distributed computing system. However, the enormous number of metric data streams received by management systems makes it extremely difficult for information technology (“IT”) administrators to monitor the metrics, detect performance abnormalities in real time, and respond in real time to performance abnormalities. Moreover, the extremely large number of metrics create a computational bottleneck for typical management systems, which delays detection of performance abnormalities. Failure to respond quickly to performance problems can interrupt services and have enormous cost implications for data center tenants, such as when a tenant's server applications stop running or fail to timely respond to client requests.

### SUMMARY

Automated processes and systems described herein are directed to detecting abnormal performance of a complex computational system of a distributed computing system. A “complex computational system” may be a collection of physical and/or virtual objects, which include server computers, data storage devices, network devices, virtual machines, containers, and applications. A single complex computational system may have hundreds of thousands, or millions, of associated metrics that are used to monitor resource usage, network usage, number of data stores, and response times, just to name a few. Automated processes and systems described herein are directed to determining time stamps of previous abnormal behavior of the complex computational system and reduce the number of metrics associated with the computational system to a smaller uncorrelated metrics. Processes and systems determine rules based on the uncorrelated metrics and the time stamps of previous abnormal behavior. Each rule may be applied to run-time metric values of the one or more uncorrelated metrics to detect abnormal behavior of the complex computational system and generate a corresponding alert in approximate real time, reducing the time and computational complexity typically associated with detecting abnormal performance of a complex computational system. Each rule may include displaying a recommendation for addressing the abnormality based on remedial measures used to correct the same abnormality in the past. Each rule may also automatically trigger an associated remedial process that automatically corrects the abnormality.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIG. 14A shows a plot of an example metric represented as a sequence of time series data associated with a resource of a distributed computing system.

FIGS. 14B-14C show examples of metrics transmitted from physical and virtual objects of a distributed computing system to a monitoring server.

FIGS. 15A-15B show plots of example non-constant and constant metrics over time.

FIG. 16A shows plots of three examples of unsynchronized metrics over the same time interval.

FIG. 16B shows a plot of metric values synchronized to a general set of uniformly spaced time stamps.

FIG. 17 shows an example metric-data matrix formed from metrics.

FIG. 18 shows a plot of metric values of three metrics in a three-dimensional space.

FIG. 19 shows an example mean-centered metric-data matrix formed from mean-centered metrics.

FIG. 20 shows a plot of the three metrics shown in FIG. 18 translated to the origin of a three-dimensional space.

FIG. 21A shows an example of a transposed mean-centered metric-data matrix obtained by transposing the mean-centered metric-data matrix in FIG. 19.

FIG. 21B shows an example covariance matrix.

FIG. 21C shows an example correlation matrix.

FIG. 22 shows a matrix representation of an eigenvector-eigenvalue problem formed for the deviation matrix.

FIG. 23 shows matrix representations of the eigenvector matrix and eigenvalue matrix of the deviation matrix.

FIG. 24 shows column vectors of normalized eigenvectors.

FIG. 25 shows three orthogonal normalized eigenvectors for the three metrics shown FIG. 20.

FIG. 26 shows computation of principal components.

FIG. 27 shows M-tuples formed from principal-component values with the same time stamps of the M principal components.

FIG. 28 shows a plot of example principal-component points of three principal components in a three-dimensional space.

FIG. 29 shows a plot of example rank-ordered variances for the first 15 principal components.

FIG. 30 shows a plot of example percentage of variance for principal components.

FIG. 31 shows n-tuples formed from principal-component values with the same time stamps.

FIG. 32 show a plot of example principal-component points in a two-dimensional principal-component space.

FIGS. 33A-33D illustrate an example of partitioning principal-component points in an n-dimensional space into two clusters.

FIG. 34 shows examples of outlier principal-component points of two clusters.

FIG. 35A shows a plot of an example system indicator over time.

FIG. 35B shows normal and outlier system-indicator values of the example system indicator in FIG. 35A.

FIG. 36A shows a plot of an example system indicator and forecast system-indicator values.

FIG. 36B shows confidence bounds for the forecast system indicators shown in FIG. 36A.

FIG. 36C shows outlier system-indicator values based on the confidence bounds.

FIG. 37 illustrates QR decomposition of the correlation matrix shown in FIG. 21B.

FIG. 38 shows an example of a decision tree technique used to generate rules.

FIGS. 39A-39B show an example of a rule associated with three uncorrelated metrics.

FIG. 40A shows three examples of rules output from the decision tree technique described above with reference to FIG. 38.

FIG. 40B shows an example of three rules applied to run-time metric data.

FIG. 41 shows an example graph of operations executed in response to a rule violation.

FIG. 42 shows an example graph of operations that may be executed in response to different combinations of rule violations.

FIG. 43 is a flow diagram illustrating an example implementation a method that detects and corrects abnormal performance of a complex computational system of a distributed computing system.

FIG. 44 is a flow diagram illustrating an example implementation of the “apply data preparation to the metrics” step referred to in FIG. 43.

FIG. 45 is a flow diagram of an example implementation of the “apply a PCA technique to obtain principal components” step referred to in FIG. 43.

FIG. 46 is a flow diagram of an example implementation of the “determine high-variance principal component” step referred to in FIG. 45.

FIG. 47 is a flow diagram of a first example implementation of the “determine time stamps of abnormal behavior of the complex computational system” step referred to in FIG. 43.

FIG. 48 is a flow diagram of a second example implementation of the “determine time stamps of abnormal behavior of the complex computational system” step referred to in FIG. 43.

FIG. 49 is a flow diagram of a third example implementation of the “determine time stamps of abnormal behavior of the complex computational system” step referred to in FIG. 43.

FIG. 50 is a flow diagram of an example implementation of the “determine uncorrelated metrics” step referred to in FIG. 43.

FIG. 51 shows a control-flow diagram of the routine “apply rules to run-time metric values of uncorrelated metrics” step referred to in FIG. 43.

### DETAILED DESCRIPTION

This disclosure is directed to automated computational processes and systems to detect abnormal performance exhibited by complex computational systems of a distributed computing system. In a first subsection, computer hardware, complex computational systems, and virtualization are described. Automated processes and systems for detecting and correcting abnormally behavior of a complex computational system of a distributed computing system are described below in a second subsection.

### Computer Hardware, Computational Systems, and Virtualization

The term “abstraction” is not, in any way, intended to mean or suggest an abstract idea or concept. Computational abstractions are tangible, physical interfaces that are implemented using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that “software implemented” functionality is provided. The digitally encoded computer instructions are a physical control component of processor-controlled machines and devices. Multi-cloud aggregations, cloud-computing services, virtual-machine containers and virtual machines, containers, communications interfaces, and many of the other topics discussed below are tangible, physical components of physical, electro-optical-mechanical computer systems.

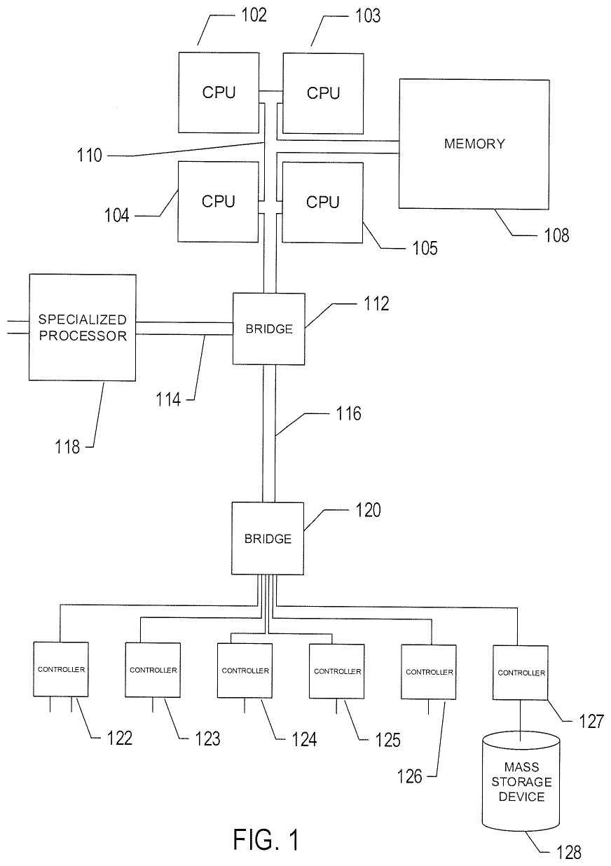

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

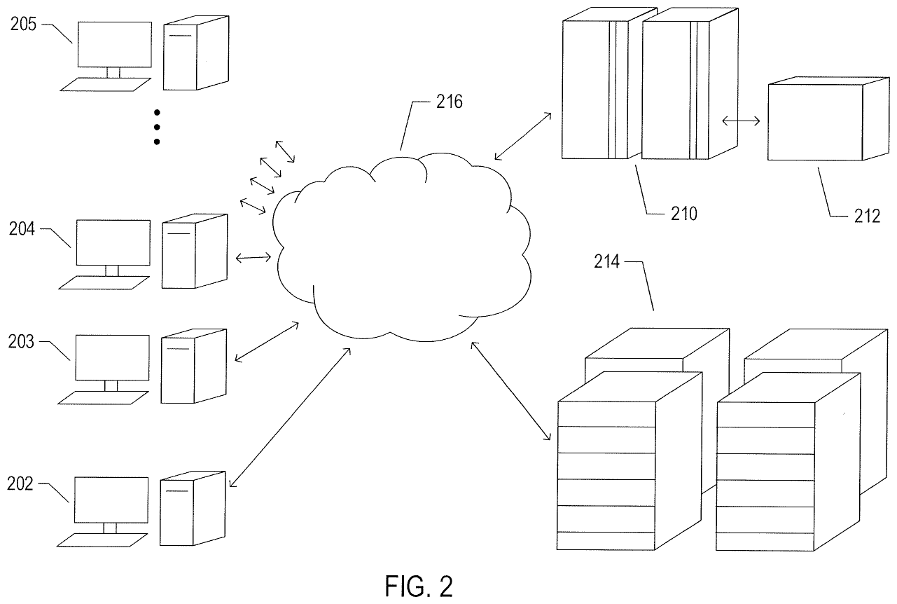

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which many PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

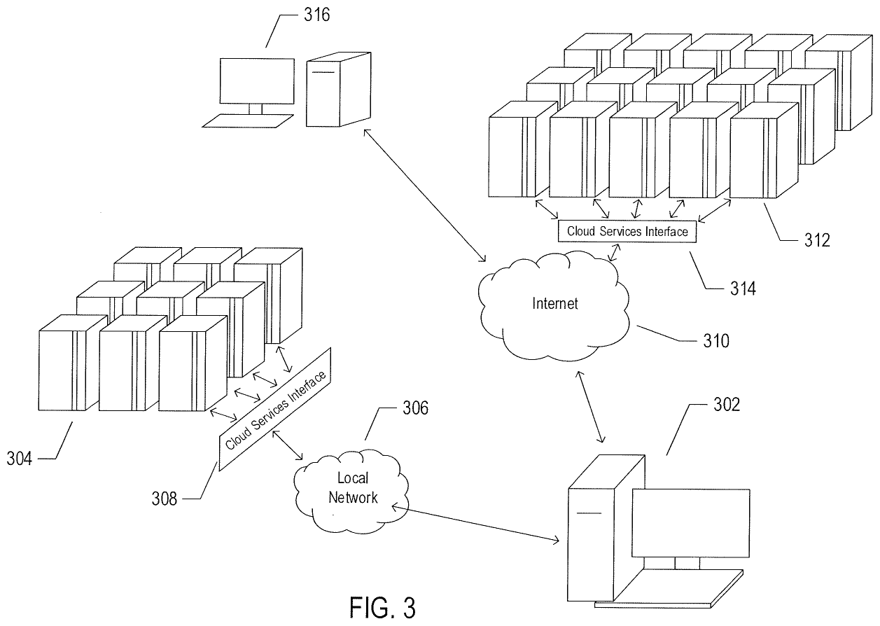

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

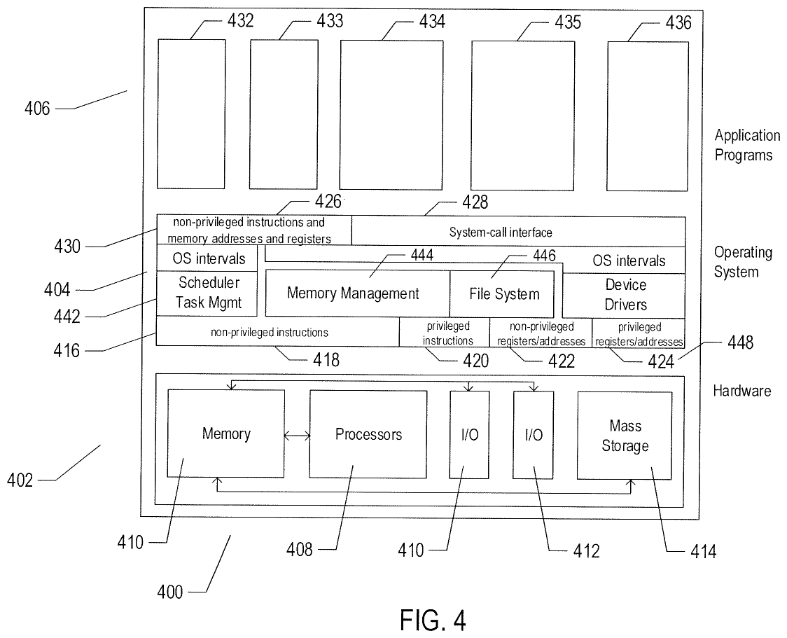

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

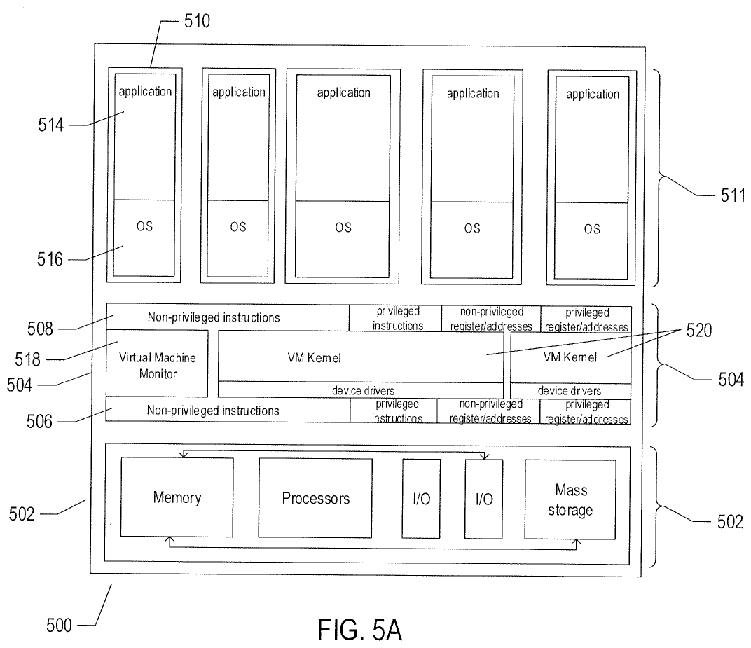

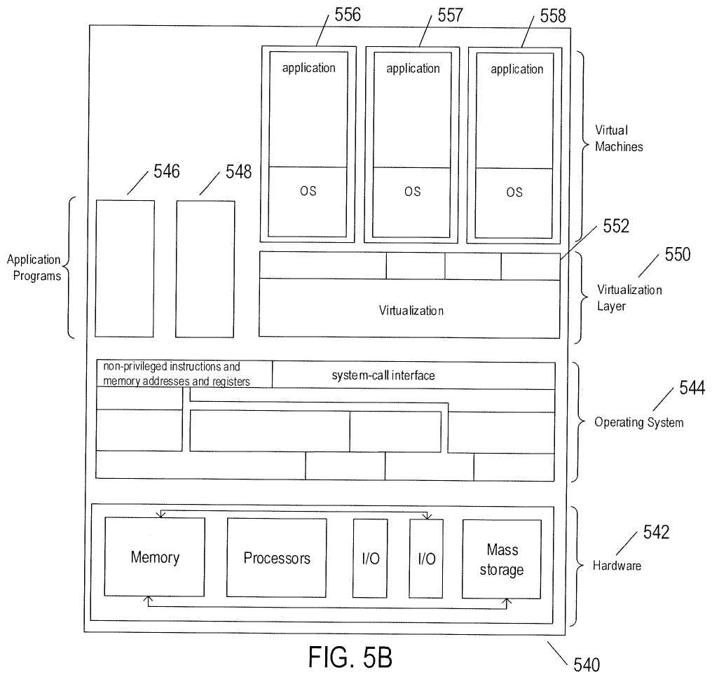

For the above reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

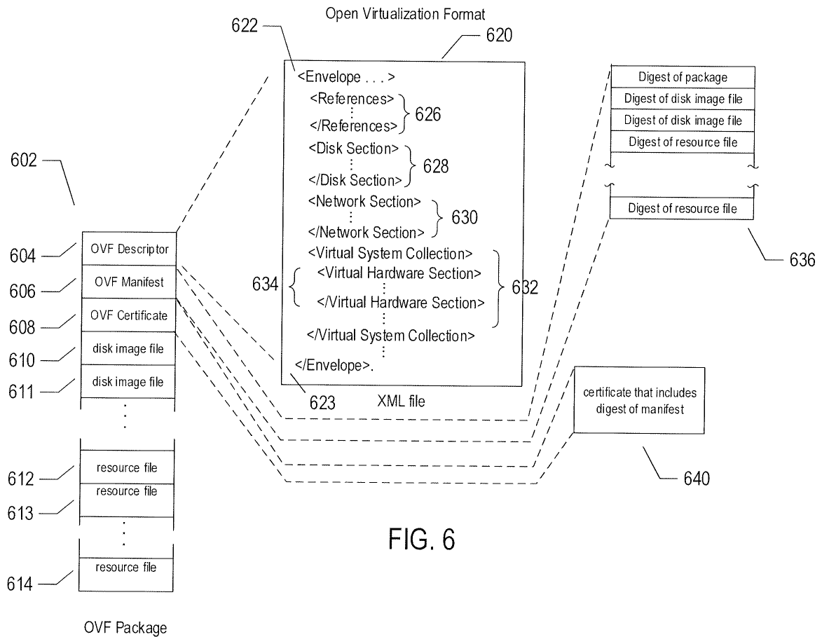

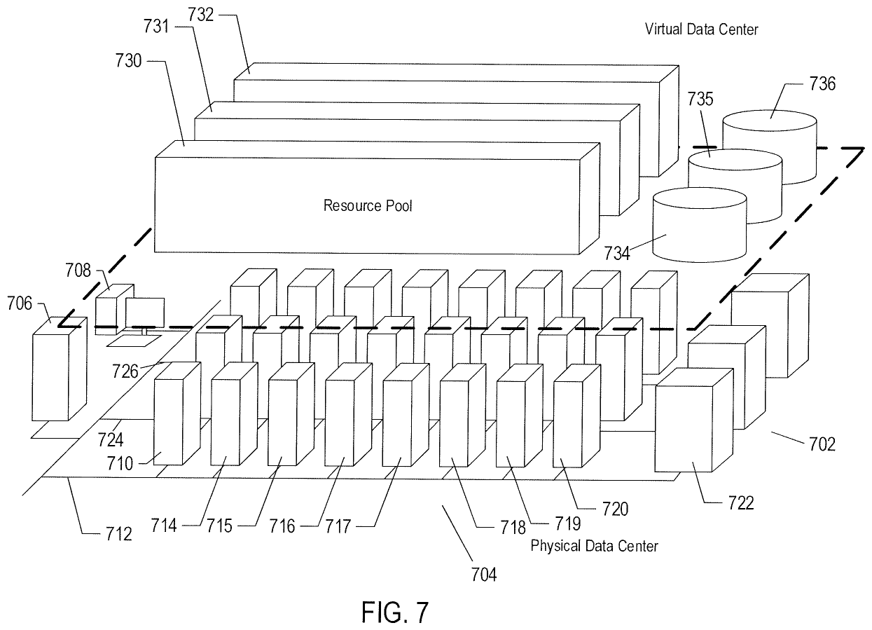

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

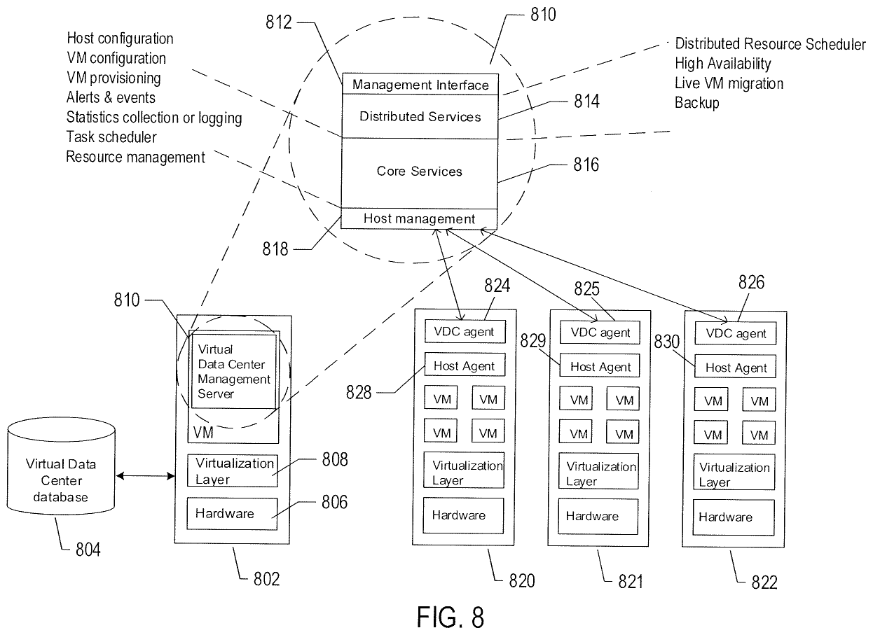

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

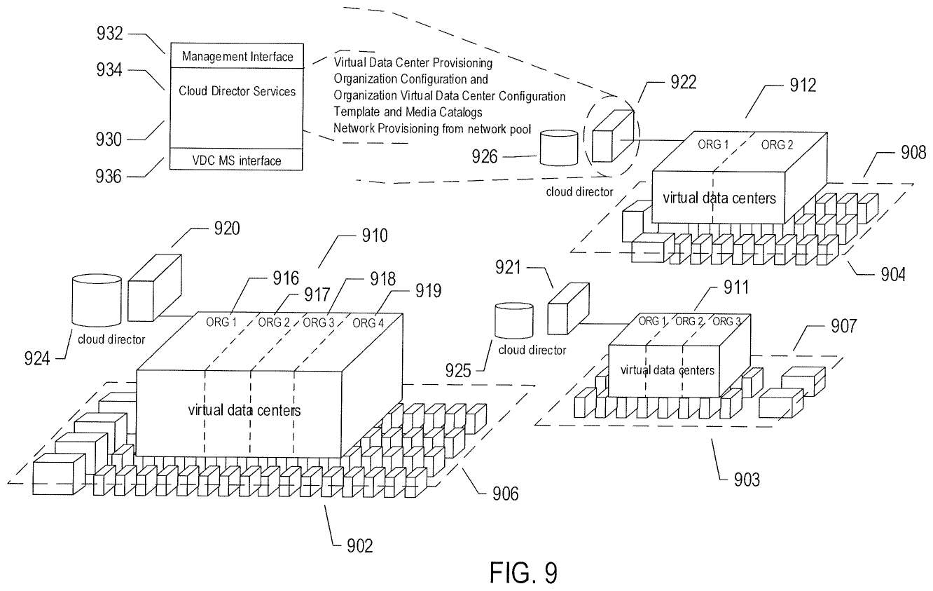

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

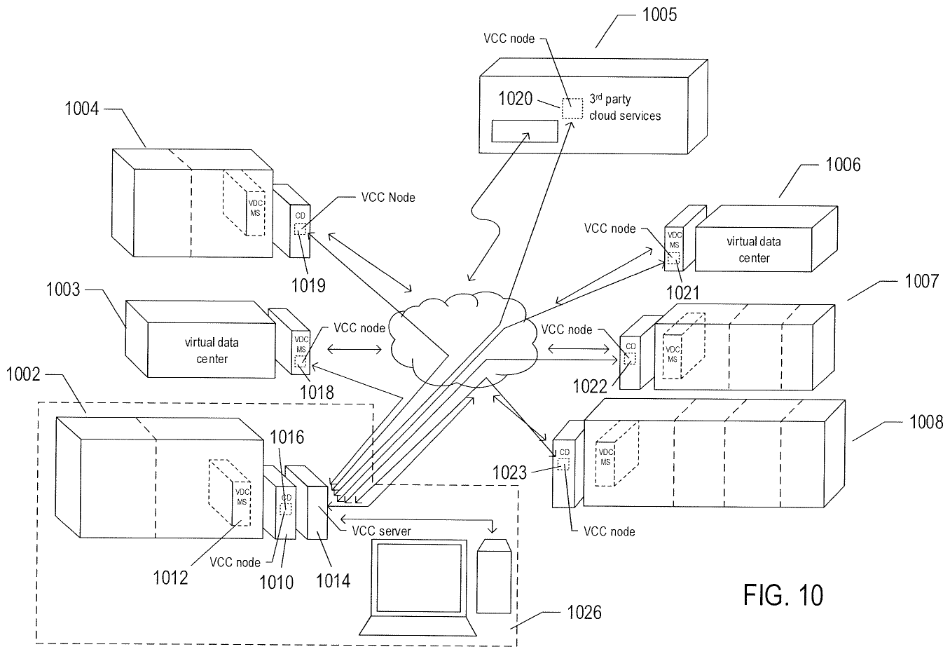

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system for use by containers. A container is a software package that uses virtual isolation to deploy and run one or more applications that access a shared operating system kernel. Containers isolate components of the host used to run the one or more applications. The components include files, environment variables, dependencies, and libraries. The host OS constrains container access to physical resources, such as CPU, memory and data storage, preventing a single container from using all of a host's physical resources. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files not included the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

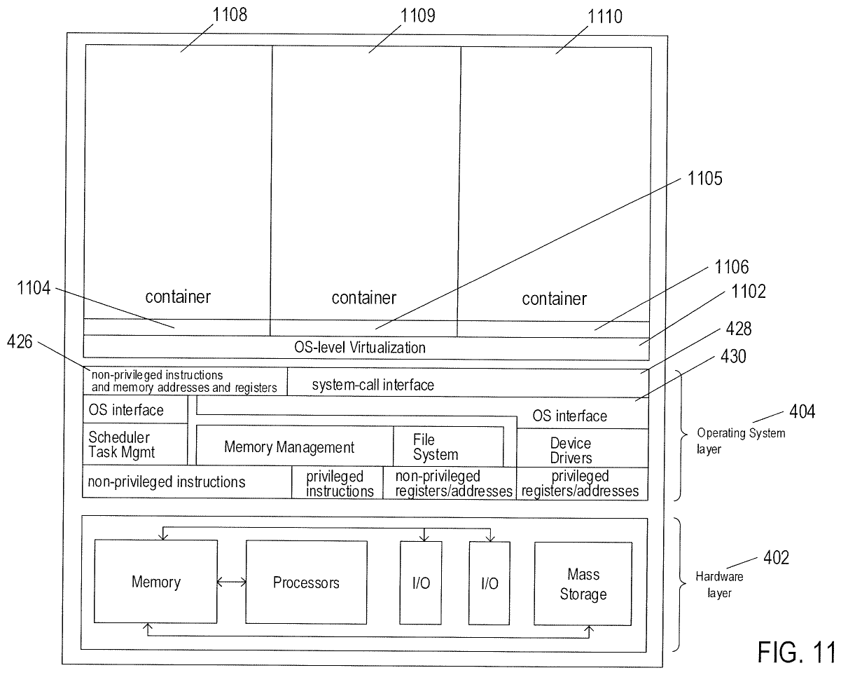

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

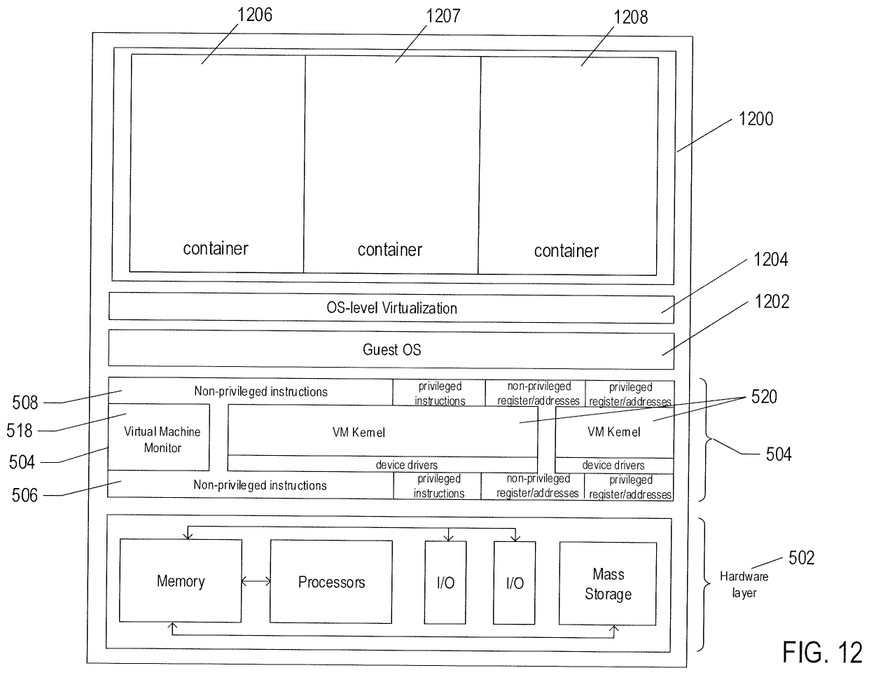

FIG. 12 shows an approach to implementing the containers on a VM. FIG. 12 shows a host computer similar to the host computer shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Automated Processes and Systems for Detecting Abnormal Behavior of a Complex Computational System of a Distributed Computing System

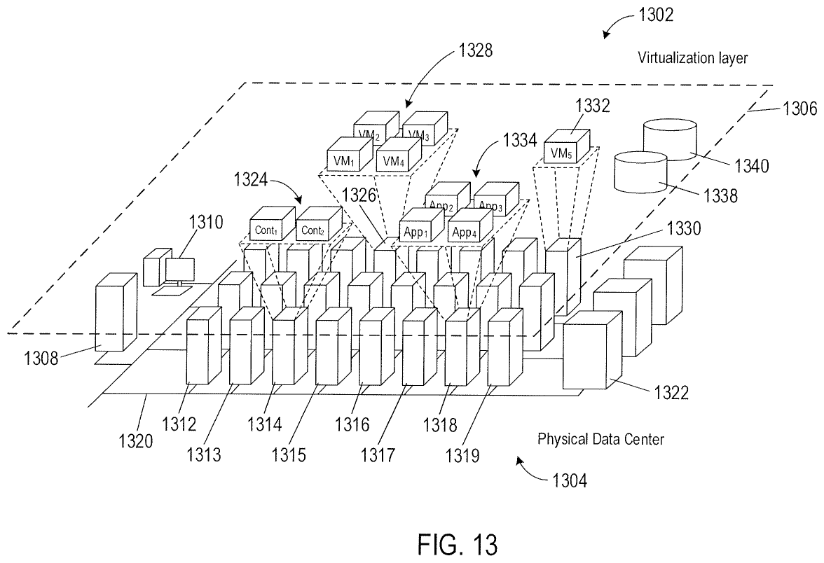

FIG. 13 shows an example of a virtualization layer 1302 located above a physical data center 1304. For the sake of illustration, the virtualization layer 1302 is separated from the physical data center 1304 by a virtual-interface plane 1306. The physical data center 1304 is an example of a distributed computing system. The physical data center 1304 comprises physical objects, including a management server computer 1308, any of various computers, such as PC 1310, on which a virtual-data-center (“VDC”) management interface may be displayed to system administrators and other users, server computers, such as server computers 1312-1319, data-storage devices, and network devices. The server computers may be networked together to form networks within the data center 1904. The example physical data center 1304 includes three networks that each directly interconnects a bank of eight server computers and a mass-storage array. For example, network 1320 interconnects server computers 1312-1319 and a mass-storage array 1322. Different physical data centers may include many different types of computers, networks, data-storage systems and devices connected according to many different types of connection topologies. The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and network interface cards formed from the physical switches, routers, and network interface cards of the physical data center 1304. Certain server computers host VMs and containers as described above. For example, server computer 1314 hosts two containers 1324, server computer 1326 hosts four VMs 1328, and server computer 1330 hosts a VM 1332. Other server computers may host applications as described above with reference to FIG. 4. For example, server computer 1318 hosts four applications 1334. The virtual-interface plane 1306 abstracts the resources of the physical data center 1304 to one or more VDCs comprising the virtual objects and one or more virtual data stores, such as virtual data stores 1338 and 1340. For example, one VDC may comprise VMs 1328 and virtual data store 1338.

In the following discussion, the term “object” refers to a physical object or a virtual object for which metric data can be collected to detect abnormal or normal behavior of a complex computational system. A physical object may be a server computer, network device, a workstation, a PC or any other physical object of a distributed computed system. A virtual object may be an application, a VM, a virtual network device, a container, or any other virtual object of a distributed computing system. The term “resource” refers to a physical resource of a distributed computing system, such as, but are not limited to, a processor, a core, memory, a network connection, network interface, data-storage device, a mass-storage device, a switch, a router, and other any other component of the physical data center 1304. Resources of a server computer and clusters of server computers may form a resource pool for creating virtual resources of a virtual infrastructure used to run virtual objects. The term “resource” may also refer to a virtual resource, which may have been formed from physical resources used by a virtual object. For example, a resource may be a virtual processor formed from one or more cores of a multicore processor, virtual memory formed from a portion of physical memory, virtual storage formed from a sector or image of a hard disk drive, a virtual switch, and a virtual router. A “complex computational system” is a set of physical and/or virtual objects. A complex computational system may comprise the distributed computing system itself, such a data center, or any subset of physical and/or virtual objects of a distributed computing system. For example, a complex computational system may be a single server computer, a cluster of server computers, or a network of server computers. A complex computational system may be a set of VMs, containers, applications, or a VDC of a tenant. A complex computational system may be a set of physical objects and the virtual objects hosted by the physical objects.

Automated processes and systems described herein are implemented in a monitoring server that monitors complex computational systems of a distributed computing system by collecting numerous streams of time-dependent metric data associated with numerous physical and virtual resources. Each stream of metric data is time series data generated by a metric source. The metric source may be an operating system of an object, an object, or the resource. A stream of metric data associated with a resource comprises a sequence of time-ordered metric values that are recorded at spaced points in time called “time stamps.” A stream of metric data is simply called a “metric” and is denoted by

v=(xᵢ)ᵢ₌₁^{N}^{ᵥ}=(x(tᵢ))ᵢ₌₁^{N}^{ᵥ} (1)

where
N is the number of metric values in the sequence;
xᵢ=x(tᵢ) is a metric value;
tᵢ is a time stamp indicating when the metric value was recorded in a data-storage device; and
subscript i is a time stamp index i=1, . . . , Nᵥ.

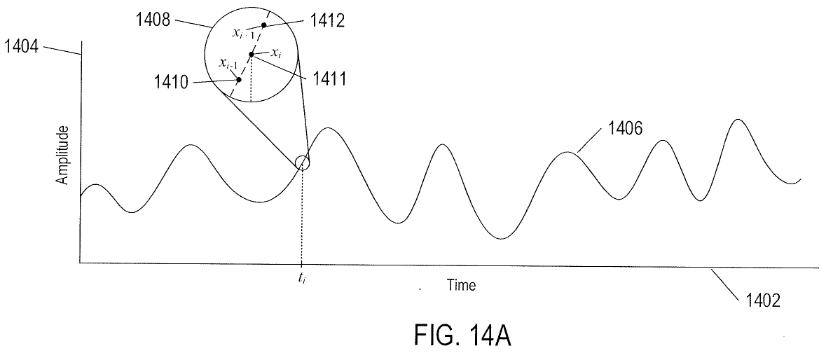

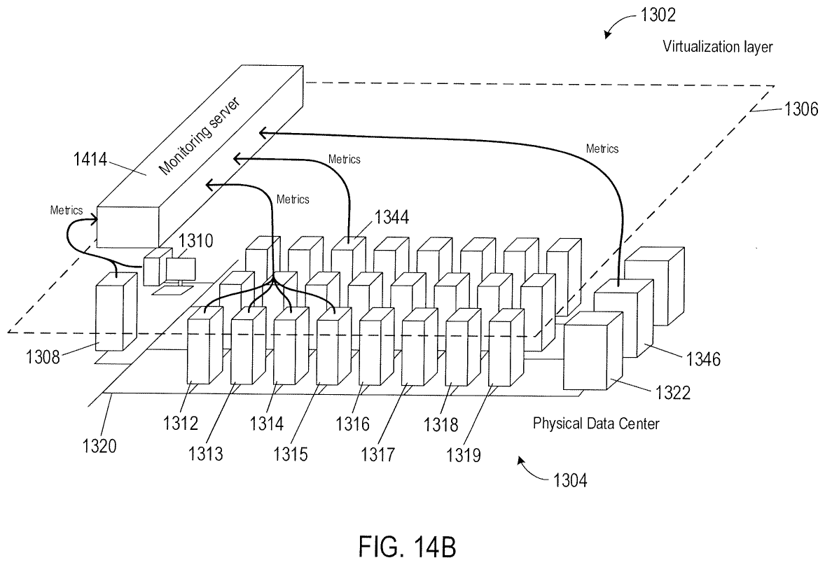

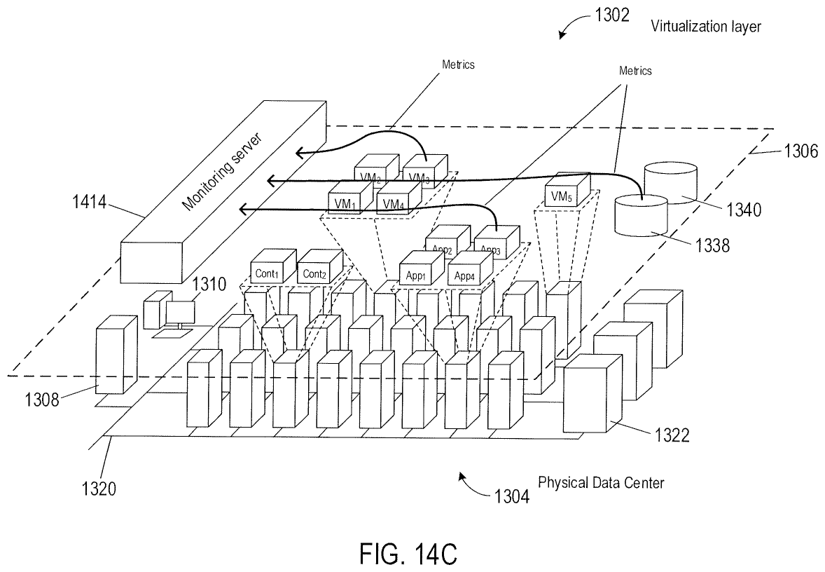

FIG. 14A shows a plot of an example metric associated with a resource. Horizontal axis 1402 represents time. Vertical axis 1404 represents a range of metric value amplitudes. Curve 1406 represents a metric as time series data. In practice, a metric comprises a sequence of discrete metric values in which each metric value is recorded in a data-storage device. FIG. 14 includes a magnified view 1408 of three consecutive metric values represented by points. Each point represents an amplitude of the metric at a corresponding time stamp. For example, points 1410-1412 represent three consecutive metric values (i.e., amplitudes) xᵢ₋₁, xᵢ, and xᵢ₊₁ recorded in a data-storage device at corresponding time stamps tᵢ₋₁, tᵢ, and tᵢ₊₁. The example metric may represent usage of a physical or virtual resource. For example, the metric may represent CPU usage of a core in a multicore processor of a server computer over time. The metric may represent the amount of virtual memory a VM uses over time. The metric may represent network throughput for a server computer. Network throughput is the number of bits of data transmitted to and from a physical or virtual object and is recorded in megabits, kilobits, or bits per second. The metric may represent network traffic for a server computer. Network traffic at a physical or virtual object is a count of the number of data packets received and sent per unit of time.

In FIGS. 14B-14C, a monitoring server 1414 collects numerous metrics associated with numerous physical and virtual resources. The monitoring server 1414 may be implemented in a VM to collect and process the metrics, as described below, to identify abnormally behaving objects of the distributed computing system and may generate recommendations to correct abnormally behaving objects or execute remedial measures, such as reconfiguring a virtual network of a VDC or migrating VMs, containers, or applications from one server computer to another. For example, remedial measures may include, but are not limited to, powering down server computers, replacing VMs disabled by physical hardware problems and failures, spinning up cloned VMs on additional server computers to ensure that the services provided by the VMs are accessible to increasing demand for services or when one of the VMs becomes compute or data-access bound. As shown in FIGS. 14B-14C, directional arrows represent metrics sent from physical and virtual resources to the monitoring server 1414. In FIG. 14B, PC 1310, server computers 1308 and 1312-1315, and mass-storage array 1346 send metrics to the monitoring server 1414. Clusters of server computers may also send metrics to the monitoring server 1414. For example, a cluster of server computers 1312-1315 sends metrics to the monitoring server 1414. In FIG. 14C, the operating systems, VMs, containers, applications, and virtual storage may independently send metrics to the monitoring server 1414, depending on when the metrics are generated. For example, certain objects may send time series data of a metric as the data is generated while other objects may only send time series data of a metric at certain times or in response to a request from the monitoring server 1414.

A complex computational system comprising tens, hundreds, or thousands of physical and/or virtual objects may have thousands or millions of associated metrics that are sent to a monitoring server, such as the monitoring server 1414. For example, a server computer alone may have hundreds of metrics that represent usage of each core of a multicore core processor, memory usage, storage usage, network throughput, error rates, datastores, disk usage, average response times, peak response times, thread counts, and power usage, just to name a few. A single virtual object, such as a VM, may have hundreds of associated metrics that monitor both physical and virtual resource usage, such as virtual CPU usage, virtual memory usage, virtual disk usage, virtual storage space, number of data stores, average and peak response times for various physical and virtual resources of the VM, network throughput, and power usage, just to name a few. The metrics collected and recorded by the monitoring server 1414 contain information that may be used to determine performance abnormalities of complex computational systems. However, typical techniques used to detect performance abnormalities of a complex computational system are not adequate for detecting run-time abnormalities because of the extremely large number of metrics associated with the complex computational systems. In other words, the extremely large number of metrics creates a computational bottleneck that delays detection of performance abnormalities, which may have significant costs for distributed computing system tenants in terms of slow response times to client requests. For example, a system administrator, or a tenant that utilizes a complex computational system of a distributed computing system to server client requests, may not be aware of a performance abnormality with a complex computational system for hours after the abnormality has started and may face an additional time delay before the abnormality is diagnosed and resolved.

Automated processes and systems described below are directed to reducing the computational complexity and time associated with detecting performance abnormalities by reducing the number of metrics used to identify performance abnormalities and determining rules that can be applied to run-time metric values of the reduced number of metrics to detect abnormalities and generate corresponding alerts that identify the abnormality associated with each rule in approximate real time, thereby reducing the time and computational complexity typically associated with detecting abnormal performance of a complex computational system. Each rule may include displaying a recommendation for addressing the abnormality associated with the rule based on remedial measures used to correct the abnormality in the past. Rules may also trigger automated remedial measures that address abnormalities identified by the rules based on remedial measures used to correct the abnormalities in the past.

Processes and systems identify metrics associated with a complex computational system. The metrics are denoted by set notation:

$${\{ {v}_{j} \}}_{j = 1}^{J} = {\{ {( {x}_{i}^{( j )} )}_{i = 1}^{{N}_{v , j}} \}}_{j = 1}^{J} = {\{ {( {x}^{( j )} ( {t}_{i} ) )}_{i = 1}^{{N}_{v , j}} \}}_{j = 1}^{J} \qquad ( 2 )$$

where
j is a metric index for the complex computational system j=1, . . . , J;
N_{v,j} is the number of the metric values in the j-th metric; and
J is an integer number of metrics.

Processes and systems prepare the metrics by deleting constant and nearly constant metrics, which are not useful in identifying abnormal performance of a complex computational system. Constant or nearly constant metrics may be identified by the magnitude of the standard deviation of each metric over time. The standard deviation is a measure of the amount of variation or degree of variability associated with a metric. A large standard deviation indicates large variability in the metric. A small standard deviation indicates low variability in the metric. The standard deviation is compared to a variability threshold to determine whether the metric has acceptable variation for identification of abnormal or normal behavior of the complex computational system.

The standard deviation of a metric may be computed by:

$${σ}_{j} = \sqrt{\frac{1}{{N}_{v , j}} {\sum }_{i = 1}^{{N}_{v , j}} {( {x}_{i}^{( j )} - {μ}_{j} )}^{2}} \qquad ( 3 a )$$

where the mean of the metric is given by

$${μ}_{j} = \frac{1}{{N}_{v , j}} {\sum }_{i = 1}^{{N}_{v , j}} {x}_{i}^{( j )} \qquad ( 3 b )$$

When the standard deviation σⱼ>εₛₜ, where εₛₜ is a variability threshold (e.g., εₛₜ=0.01), the metric vⱼ is non-constant and is retained. Otherwise, when the standard deviation σⱼ≤εₛₜ, the metric vⱼ is constant and is omitted from consideration of abnormal and normal performance of the complex computational system. Let M be the number of non-constant metrics (i.e., σⱼ>εₛₜ), where M≤J.

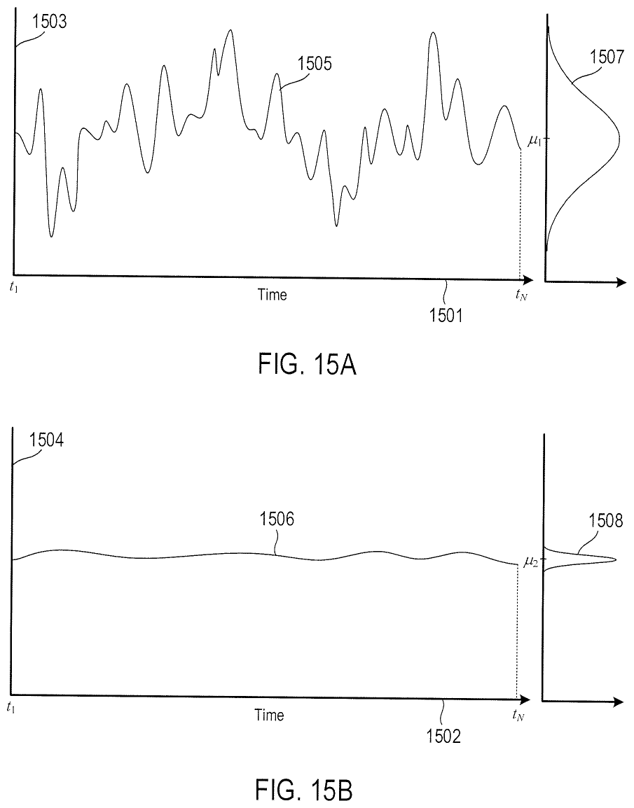

FIGS. 15A-15B show plots of example non-constant and constant metrics over time. Horizontal axes 1501 and 1502 represent time. Vertical axis 1503 represents a range of metric values for a first metric v₁. Vertical axis 1504 represents the same range of metric values for a second metric v₂. Curve 1505 represents the metric v₁ over a time interval between time stamps t₁ and t_{N}. Curve 1506 represents the metric v₂ over the same time interval. FIG. 15A includes a plot an example first distribution 1507 of the first metric centered about a mean value μ₁. FIG. 15B includes a plot an example second distribution 1508 of the second metric centered about a mean value μ₂. The distributions 1507 and 1508 reveal that the first metric 1505 has a much higher degree of variability than the second metric, which is nearly constant over the time interval.

The metrics associated with a complex computational system are typically not synchronized. For example, metric values of certain metrics may be recorded at periodic intervals, but the periodic intervals between time stamps of metric values may not be the same for the metrics associated with a complex computational system. On the other hand, metric values of some metrics may be recorded at nonperiodic intervals and are not synchronized with the time stamps of other metrics. In certain cases, the monitoring server 1414 may request metric data from metric sources at regular intervals while in other cases, the metric sources may actively send metric data at periodic intervals or whenever metric data becomes available.

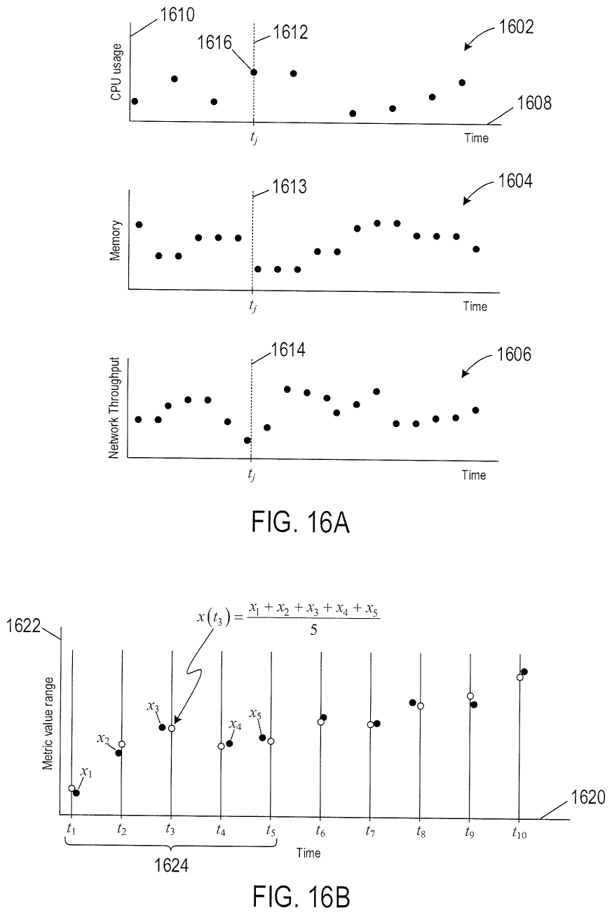

FIG. 16A shows plots of three examples of unsynchronized metrics for CPU usage 1602, memory 1603, and network throughput 1606 recorded in the same time interval. Horizontal axes, such as horizontal axis 1608, represent the length of the time interval. Vertical axes, such as vertical axis 1610, represent ranges of metric values for the CPU, memory, and network throughput. Dots represent metric values recorded at different time stamps in the time interval. CPU metric values are recorded at different periodic intervals than the memory and network throughput metric values. Dashed lines 1612-1614 mark the same time stamp, tⱼ, in the time interval. A metric value 1616 represents CPU usage for the object recorded at time stamp tⱼ. However, the memory and network throughput metrics do not have metric values recorded at the same time stamp tⱼ. As a result, the CPU usage, memory, and network throughput are not synchronized.

For the types of processing carried out by the currently disclosed processes and systems, it is convenient to ensure that the metric values for metrics used to evaluate normal and abnormal performance of a complex computational system are logically emitted in a periodic manner and that the transmission of metric data is synchronized among the metrics to a general set of uniformly spaced time stamps. Metric values may be synchronized by computing a run-time average of metric values in a sliding time window centered at each time stamp of the general set of uniformly spaced time stamps. In an alternative implementation, the metric values with time stamps in the sliding time window may be smoothed by computing a running time median of metric values in the sliding time window centered at a time stamp of the general set of uniformly spaced time stamps. Processes and systems may also synchronize the metrics by deleting time stamps of missing metric values and/or interpolating missing metric data at time stamps of the general set of uniformly spaced time stamps using linear, quadratic, or spline interpolation.

FIG. 16B shows a plot of metric values synchronized to a general set of uniformly spaced time stamps. Horizontal axis 1620 represents time. Vertical axis 1622 represents a range of metric values. Solid dots represent metric values recorded at irregularly spaced time stamps. Marks located along time axis 1620 represent time stamps of a general set of uniformly spaced time stamps. Note that the metric values are not aligned with the time stamps of the general set of uniformly spaced time stamps. Open dots represent metric values aligned with the time stamps of the general set of uniformly spaced time stamps. Bracket 1624 represents a sliding time window centered at a time stamp t₃ or the general set. The metric values x₁, x₂, x₃, x₄, and x₅ have time stamps within the sliding time window 1624 and are averaged 1632 to obtain synchronized metric value 1634 at the time stamp t₃ of the general set of uniformly spaced time stamps.

The resulting M synchronized and non-constant metrics are represented in set notation by

$${\{ {u}_{j} \}}_{j = 1}^{M} = {\{ {( {x}_{i}^{( j )} )}_{i = 1}^{N} \}}_{j = 1}^{M} = {\{ {( {x}^{( j )} ( {t}_{i} ) )}_{i = 1}^{N} \}}_{j = 1}^{M} \qquad ( 4 )$$

where N is the number of metric values in each of the M synchronized and non-constant metrics.

Processes and systems use the M synchronized and non-constant metrics (i.e., {uⱼ}ⱼ₌₁^{M}) to detect time stamps of abnormal behavior of the complex computational system over the time interval [t₁, t_{N}]. In other words, the time interval [t₁, t_{N}] is a historical time window for identifying time stamps of previous abnormal behavior of the complex computational system. Correlated metrics of the metrics {uⱼ}ⱼ₌₁^{M} are identified and discarded, and the remaining uncorrelated metrics and time stamps of previous abnormal behavior of the complex computational system are used to determine rules for detecting run-time abnormal behavior of the complex computational system.

### Determining Principal Components of the Synchronized and Non-Constant Metrics

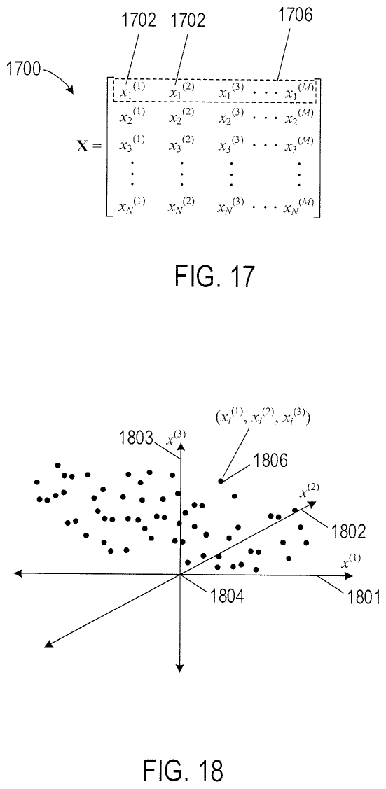

Processes and systems use a principal-component-analysis (“PCA”) technique to transform the metrics {uⱼ}ⱼ₌₁^{M} into M sets of parameters called “principal components.” Each principal component has an associated variance. The variances are used to rank order the principle components with the first (i.e., highest ranked) principal component having the largest variance and each succeeding principal component having a next largest variance with the constraint that the principal component is orthogonal in and M-dimensional space to the higher ranked principal components. The resulting principal components are an uncorrelated orthogonal basis in the M-dimensional space. The PCA technique applied to the metrics {uⱼ}ⱼ₌₁^{M} is described below with reference to FIGS. 17-32.

The PCA technique may be regarded as fitting an M-dimensional ellipsoid to the metrics {uⱼ}ⱼ₌₁^{M}. Each axis of the ellipsoid contains parameters of a principal component. The lengths of the ellipsoid axes correspond to the variances of the M principal components. For example, a short axis of the ellipsoid indicates a small variance in the direction of the short axis. By comparison, a long axis of the ellipsoid indicates a large variance in the direction of the long axis. The dimensionality of the ellipsoid may be reduced by discarding the principal components along the shortest axes, leaving higher variance principal components.

The PCA technique subtracts the average of each metric from the metric values of the metric, which centers the M metrics at the origin of an M-dimensional space. The PCA technique may use a covariance matrix when the metrics have similar scales and stable variances or a correlation matrix when the metrics do not have similar scales and may have unstable variances.

The metrics {uⱼ}ⱼ₌₁^{M} are arranged to form a metric-data matrix, X, in which each column comprises the metric values of one metrics arranged in time order according to time stamps. Each metric has a corresponding coordinate axis in an M-dimensional space. Each row of the metric-data matrix X is an M-tuple represented by a point in the M-dimensional space.

FIG. 17 shows an example metric-data matrix X 1700 formed from the metrics {uⱼ}ⱼ₌₁^{M}. Each column of the metric-data matrix X 1700 comprises a time-ordered sequence of N metric values of one of the M metrics. For example, column 1702 comprises the metric

$${u}_{1} = {( {x}_{i}^{( 1 )} )}_{i = 1}^{N}$$

and column 1704 comprises the metric

$${u}_{2} = {( {x}_{i}^{( 2 )} )}_{i = 1}^{N} .$$

Each row of the metric-data matrix X 1700 comprises metric values with the same synchronized time stamp and corresponds to an M-tuple represented by a point in an M-dimensional space. For example, metric values x₁⁽¹⁾, x₁⁽²⁾, x₁⁽³⁾, . . . , x₁^{(M)} outlined by dashed-line rectangle 1706 have the same time stamp t₁ and correspond to an M-tuple, (x₁⁽¹⁾, x₁⁽²⁾, . . . , x₁^{(M)}), a point an M-dimensional state.

FIG. 18 shows a plot of metric values of three metrics in a three-dimensional space. Directional arrows 1801-1803 represent three orthogonal coordinate axes, denoted by x⁽¹⁾, x⁽²⁾, and x⁽³⁾, that correspond to the three metrics and intersect at an origin 1804. Each axis corresponds to one of the three metrics. Each point represents a three-tuple of metric values of the three metrics. The metric values of each three-tuple have the same time stamp and correspond to a row of a metric-data matrix formed from three metrics. For example, point 1806 represents a three-tuple, (xᵢ⁽¹⁾, xᵢ⁽²⁾, xᵢ⁽³⁾), of metric values of the three different metrics with the same time stamp tt and corresponds to the i-th row of the metric-data matrix.

The PCA technique translates the metrics {uⱼ}ⱼ₌₁^{M} to the origin of the M-dimensional space. For each metric, the mean of the metric values is subtracted from the metric values to obtain a mean-centered metric given by:

$${\overline{u}}_{j} = {( {\overline{x}}_{i}^{( j )} )}_{i = 1}^{N} = {( {x}_{i}^{( j )} - {μ}_{j} )}_{i = 1}^{N} \qquad ( 5 )$$

where the overbar denotes mean centered.

The mean-centered metrics {ūⱼ}ⱼ₌₁^{M} are arranged to form a mean-centered metric-data matrix X̅ in which each column of the mean-centered metric-data matrix is a mean-centered metric that corresponds to a metric in the metric-data matrix X. In other words, the mean of each column of the metric-data matrix X 1700 is subtracted from the metric values in the column to give a corresponding column in the mean-centered metric-data matrix X̅ 1900 as illustrated in FIG. 19. Each column of the mean-centered metric-data matrix X̅ 1900 is a mean-centered metric obtained by subtracting the mean of the metric values from the metric values in the column of the metric-data matrix X 1700.

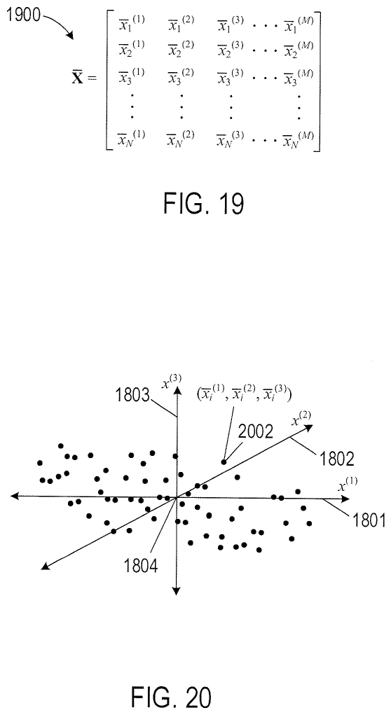

FIG. 20 shows a plot of the three metrics shown in FIG. 18 translated to the origin 1804 of the three-dimensional space. Each metric is translated by subtracting the mean of each metric from the metric values of the metric according to Equation (4). For example, the metric values of point 2002 are obtained by subtracting mean values of the three corresponding metrics from the metric values represented by the point 1806 in FIG. 18: x̅ᵢ⁽¹⁾=xᵢ⁽¹⁾−μ₁, x̅ᵢ⁽²⁾=xᵢ⁽²⁾−μ₂, and x̅ᵢ⁽³⁾=x₁⁽³⁾−μ₃.

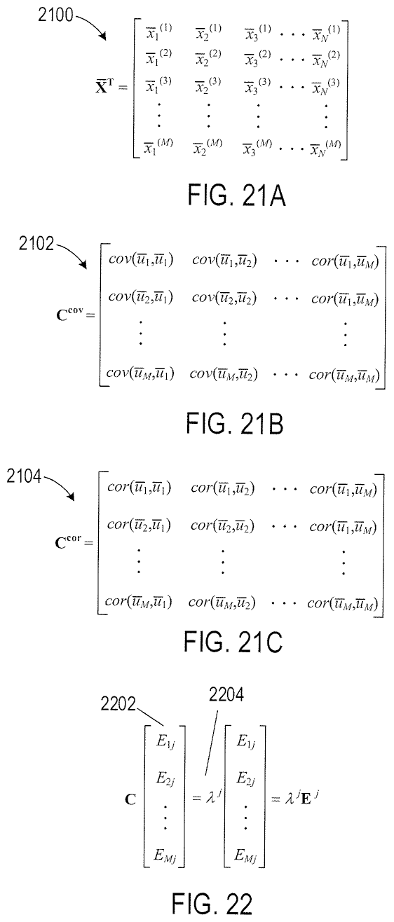

In one implementation, the PCA technique computes a covariance matrix of the mean-centered metric-data matrix X̅ 1900 by first transposing the mean-centered metric-data matrix X̅ 1900 to obtain transposed mean-centered metric-data matrix X̅^{T} 2100, shown in FIG. 21A, where superscript T denotes matrix transpose. The transposed mean-centered metric-data matrix X̅^{T} 2100 is multiplied by the mean-centered metric-data matrix X̅ 1900 to obtain a covariance matrix C^{cov} 2102 shown in FIG. 21B. The covariance matrix C^{cov} 2102 is an M×M square symmetric matrix with matrix elements given by

$$cov ( {\overline{u}}_{j} , {\overline{u}}_{k} ) = \frac{1}{N} {\sum }_{i = 1}^{N} {\overline{x}}_{i}^{( j )} {\overline{x}}_{i}^{( k )} \qquad ( 6 a )$$

where
j=1, . . . , M; and
k=1, . . . , M.
   In another implementation, the PCA technique computes a correlation matrix C^{cor} 2104 shown in FIG. 21C. The correlation matrix C^{cor} 2104 is an M×M square symmetric matrix with matrix elements given by

$$cor ( {\overline{u}}_{j} , {\overline{u}}_{k} ) = \frac{1}{N} {\sum }_{i = 1}^{N} \frac{{\overline{x}}_{i}^{( j )} {\overline{x}}_{i}^{( k )}}{{σ}_{j} {σ}_{k}} \qquad ( 6 b )$$

where
σⱼ is the standard deviation of mean-centered metric ūⱼ; and
ok is the standard deviation of mean-centered metric ūₖ.
   The standard deviations σⱼ and σₖ scale the correlation values between −1 and 1.

The covariance matrix C^{cov} 2102 and the correlation matrix C^{cor} 2104 are measures of deviations between the pairs of mean-centered metrics. In the following discussion of the PCA technique, the term “deviation matrix” refers to the covariance matrix or the correlation matrix, depending on which of the two matrices is selected to perform the PCA technique. When the metrics exhibit stable variances, the deviation matrix, denoted by C, used to perform PCA may be the covariance matrix C^{cov} or the correlation matrix C^{cor}. Alternatively, when the metrics exhibit unstable variances, the deviation matrix C used to perform the PCA technique is the correlation matrix C^{cor}.

The PCA technique computes eigenvalues and corresponding mutually orthogonal eigenvectors are computed from the deviation matrix. The eigenvectors are normalized. Each normalized eigenvector corresponds to an axis of an ellipsoid associated with the distribution of the M metrics. The fraction of the variance that each eigenvector represents may be determined by dividing the eigenvalue corresponding to that eigenvector by the sum of all eigenvalues.

The PCA technique computes eigenvalues and eigenvectors for an eigenvector-eigenvalue problem formed for the deviation matrix C:

CE^{j}=λⱼE^{j} (7)

where
E^{j} represents the j-th eigenvector;
λⱼ represents the j-th eigenvalue; and
j=1, . . . , M.
   FIG. 22 shows a matrix representation of the eigenvector-eigenvalue problem formed for the deviation matrix C with the eigenvector E^{j} represented by an M×1 column vector 2202 and the eigenvalue λⱼ 2204 is a scalar value. Equation (7) is equivalent to CE^{j}−λⱼE^{j}=0 with the λⱼE^{j}=λⱼIE^{j}, where I is the M×M identity matrix. Equation (7) can be rewritten as

(C−λⱼI)E^{j}=0 (8)

The M eigenvalues are computed by solving the characteristic equation:

det(C−λⱼI)=0 (9)

where “det” denotes the determinant operator.

After the eigenvalues are computed, corresponding eigenvectors are numerically computed from Equation (9). In other words, each eigenvalue has an associated eigenvector computed from Equation (7). An eigenvalue and the corresponding eigenvector are called an eigenpair. Because the deviation matrix C is symmetric, the deviation matrix C may be diagonalized in terms of the eigenvectors and eigenvalues as follows:

C=EΛE^{T} (10)

where
E is the eigenvector matrix formed from the eigenvectors of the deviation matrix C;
E^{T} is the transpose of the eigenvector matrix; and
Λ is the eigenvalue matrix formed from eigenvalues {λⱼ}ⱼ₌₁^{M} of the deviation matrix C.

FIG. 23 shows matrix representations of the eigenvector matrix and eigenvalue matrix of Equation (10). The eigenvector matrix E is an M×M matrix in which the columns of the eigenvector matrix are the eigenvectors of the deviation matrix C. The eigenvalue matrix A is an M×M diagonal matrix with the eigenvalues of the deviation matrix C located along the diagonal. The eigenvectors of the eigenvector matrix E and the corresponding eigenvalues of the eigenvalue matrix A are eigenpairs. For example, as shown in FIG. 23, the first eigenvector E¹ 2302 corresponds to the first eigenvalue λ₁ 2304. The eigenvectors of the eigenvector matrix E are orthogonal (i.e., E^{j}·E^{k}=0 for j≠k, j=1, . . . , M, and k=1, . . . , M).

Each eigenvector corresponds to an axis of an elliptical distribution of the mean-centered metrics {ūⱼ}ⱼ₌₁^{M} in the M-dimensional space. Each eigenvalue is proportional to the magnitude of the variance in the direction of the corresponding eigenvector. A large eigenvalue corresponds to a larger variance in the spread of the mean-centered metrics {ūⱼ}ⱼ₌₁^{M} in the direction of the corresponding eigenvector than in an orthogonal direction of an eigenvector with a smaller corresponding eigenvalue. The eigenvalues are rank ordered from largest to smallest. Let λ₁^{ro}, . . . , λ_{M}^{ro} denote the rank ordered eigenvalues of the eigenvalues {λⱼ}ⱼ₌₁^{M}, where λ₁^{ro}>λ₂^{ro}> . . . >λ_{M}^{ro}, and the superscript “ro” identifies the eigenvalues as rank ordered with λ₁^{ro} and λ_{M}^{ro} corresponding to the largest and the smallest of the eigenvalues {uⱼ}ⱼ₌₁^{M}. Let Eᵣₒ¹, . . . , Eᵣₒ^{M} denote the corresponding eigenvectors of the rank ordered eigenvalues λ₁^{ro}, . . . , λ_{M}^{ro}. The largest eigenvalue λ₁^{ro} corresponds to the largest variation in the spread of the mean-centered metrics {ūⱼ}ⱼ₌₁^{M} in the direction of the corresponding eigenvector Eᵣₒ¹. By contrast, the smallest eigenvalue λ_{M}^{ro} corresponds to the smallest variation in the spread of the mean-centered metrics {ūⱼ}ⱼ₌₁^{M} in the direction of the corresponding eigenvector Eᵣₒ^{M}. Each eigenvector may be normalized to obtain normalized eigenvectors as follows:

$${e}^{j} = \frac{{E}_{ro}^{j}}{‖ {E}_{ro}^{j} ‖} \qquad ( 11 )$$

where ∥⋅∥ is the Euclidean norm or length of the eigenvector.

FIG. 24 shows column vectors of M normalized eigenvectors. Normalized eigenvector e¹ corresponds to the largest rank order eigenvalue λ₁^{ro}, normalized eigenvector e² corresponds to the second largest rank order eigenvalue λ₂^{ro}, normalized eigenvector e³ corresponds to the third largest rank order eigenvalue λ₃^{ro}, and normalized eigenvector e^{M} corresponds to the smallest rank order eigenvalue λ_{M}^{ro}.

FIG. 25 shows three orthogonal normalized eigenvectors e¹, e², and e³ for the three metrics shown FIG. 20. Ellipse 2502 represents a three-dimensional elliptical region of space that is centered at the origin 1804 and represents the general shape of the space occupied by the three metrics. The normalized eigenvectors e¹, e², and e³ correspond to directions of the greatest variance, medium variance, and smallest variance of the three metrics and correspond to the largest, medium, and smallest eigenvalues of the three metrics. For example, normalized vector e¹ points in the direction of the longest axis of the ellipsoid 2502.

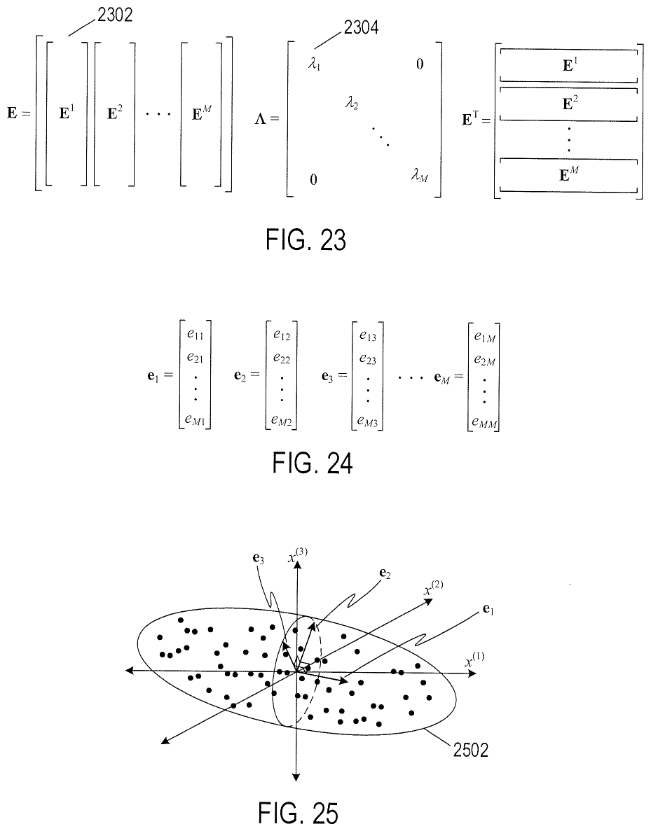

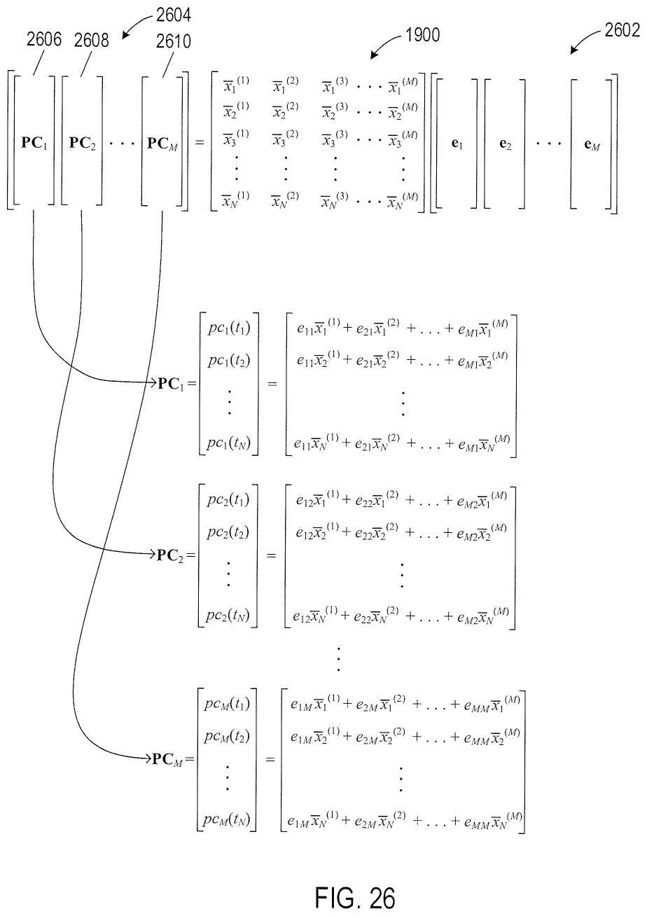

The mean-centered metrics {ūⱼ}ⱼ₌₁^{M} are projected onto M principal-component axes, denoted by PC₁, PC₂, . . . , PC_{M}, that are aligned with the directions of the normalized eigenvectors to obtain M principal components. FIG. 26 shows computation of the M-principal components based on the mean-centered metrics {ūⱼ}ⱼ₌₁^{M}. The mean-centered metric-data matrix X̅ 1900 is multiplied by a normalized eigenvector matrix 2602 formed from the normalized eigenvectors, shown in FIG. 24, to obtain a principal-component matrix 2604. Each column of the principal-component matrix 2604 is a principal component comprising N principal-component values located along a corresponding principal component axis. For example, the first principal component PC₁ is represented by column 2606 and comprises principal component values pc₁(t₁), pc₁(t₂), . . . , pc₁(t_{N}) located along the principal-component axis PC₁. The second principal component PC₂ is represented by column 2608 and comprises principal component values pc₂(t₁), pc₂(t₂), . . . , pc₂(t_{N}) located along the principal-component axis PC₂. The M-th principal component PC_{M} is represented by column 2610 and comprises principal-component values pc_{M}(t₁), pc_{M}(t₂), . . . , pc_{M}(t_{N}) located along the principal-component axis PC_{M}. Principal component values with the same time stamp form an M-tuple that may be represented by a point in an M-dimensional space.

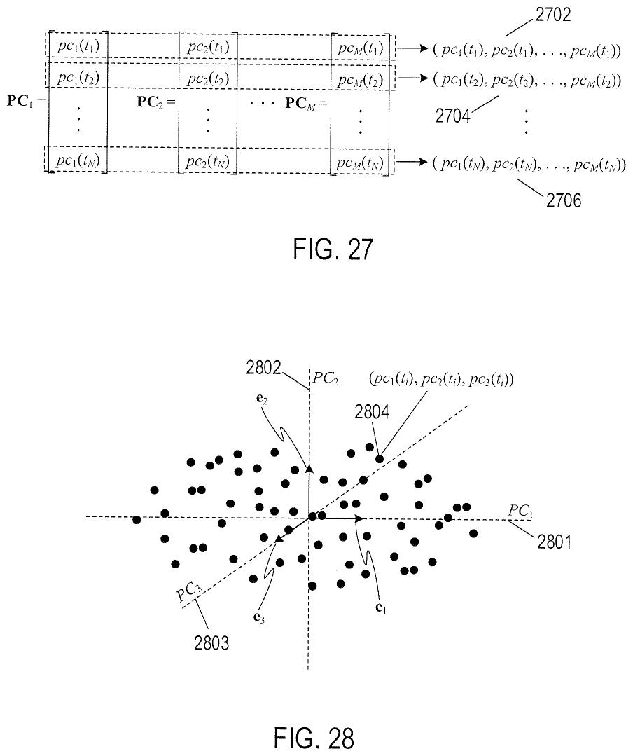

FIG. 27 shows M-tuples formed from principal-component values with the same time stamps of the principal components PC₁, PC₂, . . . , PC_{M}. For example, M-tuple 2702 comprises principal-component values with time stamp t₁, M-tuple 2704 comprises principal-component values with time stamp t₂, and M-tuple 2706 comprises principal-component values with time stamp t_{N}. Each M-tuple corresponds to a point in an M-dimensional space and is called a “principal-component point.”

FIG. 28 shows a plot of example principal-component points of three principal components in a three-dimensional space. Dashed lines 2801-2803 represent principal-component axes PC₁, PC₂ and PC₃, respectively, that are aligned with the normal eigenvectors e₁, e₂ and e₃ described above with reference to FIG. 25. Principal-component points represent three tuples of three principal-component values of the three principal components PC₁, PC₂ and PC₃ with the same time stamp. For example, principal-component point 2804 represents principal-component values pc₁(tᵢ), pc₂(tᵢ) and pc₃(tᵢ) of the corresponding principal components PC₁, PC₂ and PC₃.

The PCA technique retains principal components with the largest variances and discards the rest of the principal components. The variance of each principal component is computed by:

$$Var ( {PC}_{j} ) = \frac{1}{N} {\sum }_{i = 1}^{N} {( p {c}_{j} ( {t}_{i} ) - μ ( P {C}_{j} ) )}^{2} \\ where \\ j = 1 , … , M ; and \\ μ ( P {C}_{j} ) = \frac{1}{N} {\sum }_{i = 1}^{N} {pc}_{j} ( {t}_{i} ) . \qquad ( 12 )$$

The variances of the principal components correspond to the rank ordered eigenvalues of the deviation matrix. In other words, the variances of the principal components are used to rank order the principal components as follows: Var(PC₁)>Var(PC₂)> . . . >Var(PC_{M}). The first principal component has the largest variance, the second principal component has the second large variance, and so on with the M-th principal component having the smallest variance.

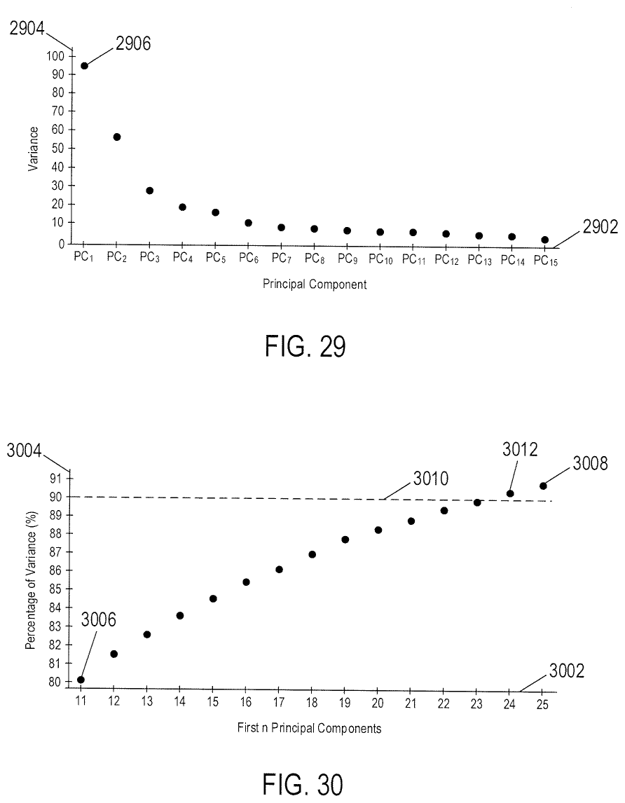

FIG. 29 shows a plot of example rank-ordered variances for the first 15 principal components. Each mark located along horizontal axis 2902 represents one of 15 principal components. Vertical axis 2904 represents a variance range. Points are variances of the principal components. For example, point 2906 is the variance of the first principal component PC₁. In the example of FIG. 29, the variances decrease exponentially.

Subsets of principal components are formed from the principal components in which each subset of principal components comprises the first n principal components with the n largest corresponding variances. In other words, each subset of first n principal components comprises n principal components with the n largest variances. For example, a first three (i.e., n=3) principal components comprises the principal components with the three largest corresponding variances, and a first four (i.e., n=4) principal components comprises the principal components with the four largest corresponding variances. A percentage of variance is computed for the first n principal components (i.e., n<M) by

$$Percent \text{-} Var ( n ) = \frac{{\sum }_{i = 1}^{n} V ( P {C}_{j} )}{{\sum }_{j = 1}^{M} V ( P {C}_{j} )} \times 100 \qquad ( 13 )$$

A threshold may be used to determine the fewest number of first n principal components. For example, the first n principal components contain most of the variation, when the following condition is satisfied

Percent−Var(n)≥Th_{perc_var} (14)

where Th_{perc_var} is a percentage of variance threshold (e.g., Th_{perc_var} may be set to any value between about 85% and about 99%).
The smallest percentage of variance that satisfies the condition given by Equation (14) gives the smallest number of principal components that contain most of the variation of the metrics. The smallest subset of first n principal components with the corresponding smallest percentage of variance that satisfies the condition given by Equation (14) are called “high-variance principal components.” The remaining M−n principal components do not have sufficient variance and may be discarded, reducing the dimensionality of the principal-component space from M dimensions to n dimensions.

FIG. 30 shows a plot of example percentage of variance for first 11 principal components through first 25 principal components. Each mark along horizontal axis 3002 corresponds to a first n principal components, where n ranges from 11 to 25. Vertical axis 3004 corresponds to a range of percentage of variances. Points represent the percentage of variance for different numbers of principal components. For example, point 3006 represents a percentage of variance for the first 11 principal components and point 3008 represents a percentage of variance for the first 25 principal components. Dashed line 3010 represents a percentage of variance threshold of 90%. The plot of percentage of variances indicates that the first 24 principal components identified by point 3012 contain about 90% of the variation of the mean-centered metrics {uⱼ}ⱼ₌₁^{M}. In other words, because the percentage of variance threshold is set to 90%, the first 24 principal components may be used to characterize variance of the mean-centered metrics {uⱼ}ⱼ₌₁^{M}. In other words, if the first 24 principal components characterize 90% of the variation in the metrics, the remaining M−24 principal components may be discarded for lack of sufficient variation, thereby reducing the dimensionality of the principal-component space from the M-dimensional principal-component space to a 24-dimensional principal-component space.

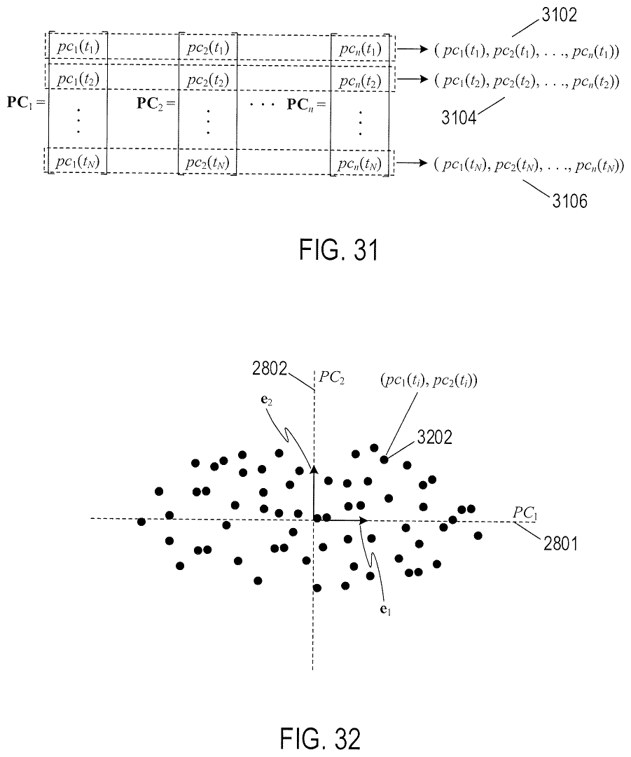

FIG. 31 shows n-tuples formed from principal-component values with the same time stamps from the first n principal components PC₁, PC₂, . . . , PCₙ. For example, n-tuple 3102 comprises n principal-component values with time stamp t₁, n-tuple 3104 comprises principal-component values with time stamp t₂, and n-tuple 3106 comprises principal-component values with time stamp t_{N}. Each n-tuple corresponds to a point in an n-dimensional space and is called a principal-component point.

Suppose that Percent-Var(2) for the principal components shown in FIG. 28 satisfies the condition given by Equation (12). The principal components PC₁ and PC₂ are identified as high-variance principal components. As a result, the principal component PC₃ is discarded, which reduces the dimensionality of the principal-component space, as shown in FIG. 28, from three dimensions to two dimensions, as shown in FIG. 32. For example, the three-dimensional principal-component point 2804 in FIG. 28 is reduced from the principal-component values pc₁(tᵢ), pc₂(tᵢ) and pc₃(tᵢ) to a two-dimensional principal-component point 3202 in FIG. 32 with the two principal-component values pc₁(tᵢ) and pc₂(tᵢ).

### Labeling Time Stamps of Metrics of a Complex Computational System

In one implementation, processes and systems may use k-means clustering to determine time stamps of abnormal behavior of the complex computational system over the time interval [t₁, t_{N}]. Let { [symbol] (tᵢ)}ᵢ₌₁^{N} denote principal-component points in n-dimensional space, where [symbol] (tᵢ)=(pc₁(tᵢ),pc₂(tᵢ), . . . , pcₙ(tᵢ)) is a principal-component in n-dimensional space. K-means clustering is an iterative process of partitioning the N principal-component points into k clusters such that each principal-component point belongs to the cluster with the closest cluster center. K-means clustering begins with the full N principal-component points and k cluster centers denoted by { [symbol] ᵣ}ᵣ₌₁^{k}, where [symbol] ᵣ is an n-dimensional cluster center. Each principal-component point [symbol] (tᵢ) is assigned to one of the k clusters defined by:

Cₛ^{(m)}={ [symbol] (tᵢ):| [symbol] (tᵢ)− [symbol] ₛ^{(m)}|≤| [symbol] (tᵢ)− [symbol] ᵣ^{(m)}|∀j,1≤r≤k} (15)

where
Cₛ^{(m)} is the s-th cluster s=1, 2, . . . , k; and
superscript m is an iteration index m=1, 2, 3, . . . .
   The cluster center [symbol] ₛ^{(m)} is the mean location of the principal-component points in the s-th cluster. A next cluster center is computed at each iteration as follows:

$${\vec{q}}_{s}^{( m + 1 )} = \frac{1}{\vert {C}_{s}^{( m )} \vert} {\sum }_{\vec{pc} ( {t}_{i} ) ∈ {C}_{s}^{( m )}} \vec{pc} ( {t}_{i} ) \qquad ( 16 )$$

where |Cₛ^{(m)}| is the number of data points in the s-th cluster.

For each iteration m, Equation (15) is used to determine which cluster Cₛ^{(m)} each principal-component point [symbol] (tᵢ) belongs to followed by recomputing the cluster center according to Equation (16). The computational operations represented by Equations (15) and (16) are repeated for each iteration, m, until the principal-component points in each of the k clusters do not change. The resulting clusters are represented by:

Cₛ={ [symbol] (tₚ)}ₚ₌₁^{N}^{ₛ} (17)

where
Nₛ is the number of principal-component points in the cluster Cₛ;
s=1, 2, . . . , k; and
p is a time-stamp index of principal-component points in the cluster Cₛ.
   The number of principal-component points in each cluster sums to N (i.e., N=N₁+N₂+ . . . +Nₖ)

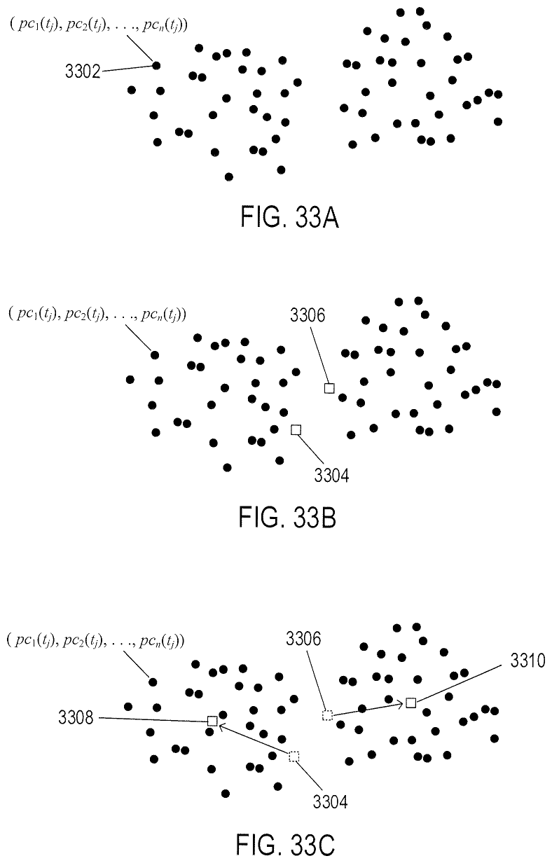

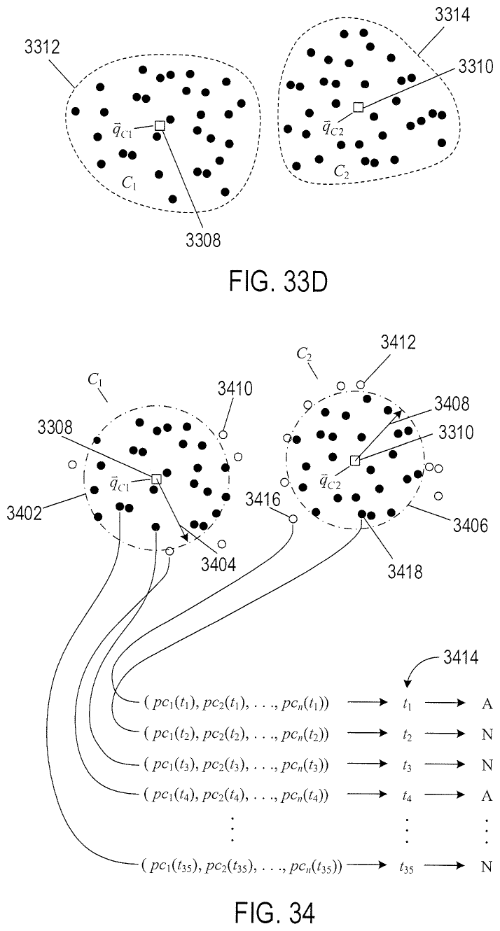

FIGS. 33A-33D illustrate an example of partitioning principal-component points in an n-dimensional space into two clusters. FIG. 33A shows an example plot of 35 principal-component points in an n-dimensional space. Each principal-component point represents an n-tuple of principal-component values at the same time stamp. For example, a point 3302 represents an n-tuple of principal-component values, (pc₁(tᵢ), pc₂(tᵢ), . . . , pcₙ(tᵢ)), with the same time stamp tᵢ. In FIG. 33B, two initial cluster centers denoted by boxes 3304 and 3306 are placed in the n-dimensional space. K-means clustering is repeatedly applied, as described above with reference to Equations (15) and (16), until each of the principal-component points have been assigned to one of two clusters. FIG. 33C shows the initial cluster centers 3304 and 3306 moved to corresponding cluster centers 3308 and 3310 of two clusters of principal-component points after several iterations with Equations (15) and (16). FIG. 33D shows two clusters of principal-component points, denoted by C₁ and C₂, outlined by dashed lines 3312 and 3314, respectively. Cluster center [symbol] _{C1} 3308 is the center of cluster C₁, and cluster center [symbol] _{C2} 3310 is the center of cluster C₂.

Assuming the distances between the principal-component points and corresponding cluster centers are normally distributed, principal-component points with distances located more than Z standard deviations from the corresponding cluster center are identified as outliers. In other words, principal-component points that satisfy the following condition are outliers:

μ_{Cs}+Zσ_{Cs}<∥ [symbol] _{Cs}− [symbol] (tₚ)∥₂ (18)

where
[symbol] _{Cs} is cluster center of the cluster Cₛ;
[symbol] (tₚ) is the p-th principal-component point in the cluster Cₛ;
Z is the number of standard deviations;
∥⋅∥₂ is the n-dimensional Euclidean norm;

$${μ}_{C s} = \frac{1}{{N}_{s}} {\sum }_{p = 1}^{{N}_{s}} {‖ {\vec{q}}_{c s} - \vec{pc} ( {t}_{p} ) ‖}_{2}$$

$${σ}_{C s} = \sqrt{\frac{{\sum }_{p = 1}^{{N}_{s}} {( {‖ {\vec{q}}_{c s} - \vec{pc} ( {t}_{p} ) ‖}_{2} - {μ}_{Cs} )}^{2}}{{N}_{s}}}$$

A time stamp of an outlier principal component corresponds to a point in time when behavior of the complex computational system is abnormal. The time stamp of an outlier principal-component point is labeled abnormal. The time stamp of normal principal-component point is labeled normal.

FIG. 34 shows examples of outlier principal-component points of the clusters C₁ and C₂ in FIG. 33. Dashed-dot circle 3402 represents an n-dimensional hypersphere with a radius 3404 of length μ_{C1}+Zσ_{C1} centered at the cluster center \vec{q}_{C1} 3308. Dashed-dot circle 3406 represents an n-dimensional hypersphere with a radius 3408 of length μ_{C2}+Zσ_{C2} centered at the cluster center \sqrt{q}_{C2} 3310. Open dots represent principal-component points of the respectively clusters C₁ and C₂ that satisfy the condition given by Equation (18) and are identified as outliers. For example, outlier principal-component point 3410 belongs to the cluster C₁ and is located outside the hypersphere 3404. Outlier principal-component point 3412 belongs to the cluster C₂ and is located outside the hypersphere 3408. The time stamps of the outlier principal-component points correspond to points in time when the behavior of the complex computational system is abnormal and are labeled as abnormal. The time stamps of the principal-component points that lie within the respective n-dimensional hyperspheres are labeled as normal.

FIG. 34 also shows an example of time stamps 3414 of normal and outlier principal-component points. Time stamps of normal principal-component points are labeled by a letter “N” and correspond to points in time when the behavior of the complex computational system is normal. On the other hand, time stamps of outlier principal-component points are labeled by a letter “A” and correspond to points in time when the behavior of the complex computational system is abnormal. For example, principal-component point 3416 is an outlier with a time stamp t₁ that has been labeled as abnormal and principal-component point 3418 is an outlier with a time stamp t₂ that has been labeled as normal.

In another implementation, a system indicator may be computed from the high-variance principal components. The system indicator is a time-dependent sequence of system-indicator values denoted by (pc_{X}(tᵢ))ᵢ₌₁^{N}, where the subscript X denotes principal-component average value, principal-component average-absolute value, or principal-component distance. The system-indicator values are used to label time stamps of normal and abnormal performance of the complex computational system.

In one implementation, the system indicator may be a principal-component average. For each time stamp, a principal-component average value is computed as follows:

$${pc}_{ave} ( {t}_{i} ) = \frac{1}{n} {\sum }_{j = 1}^{n} p {c}_{j} ( {t}_{i} ) \qquad ( 19 a )$$

In another implementation, the system indicator may be a principal-component average absolute value. For each time stamp, a principal-component average-absolute value is computed as follows:

$$p {c}_{ave \text{-} ab s} ( {t}_{i} ) = \frac{1}{n} {\sum }_{j = 1}^{n} \vert {pc}_{j} ( {t}_{i} ) \vert \qquad ( 19 b )$$

where |⋅| represents the absolute value operator.

In another implementation, a system-indicator value may be a principal-component distance computed as a distance from principal-component values with the same time stamp to the origin of the principal-component space:

$${pc}_{distance} ( {t}_{i} ) = \sqrt{{\sum }_{j = 1}^{n} {( p {c}_{j} ( {t}_{i} ) )}^{2}} \qquad ( 19 c )$$

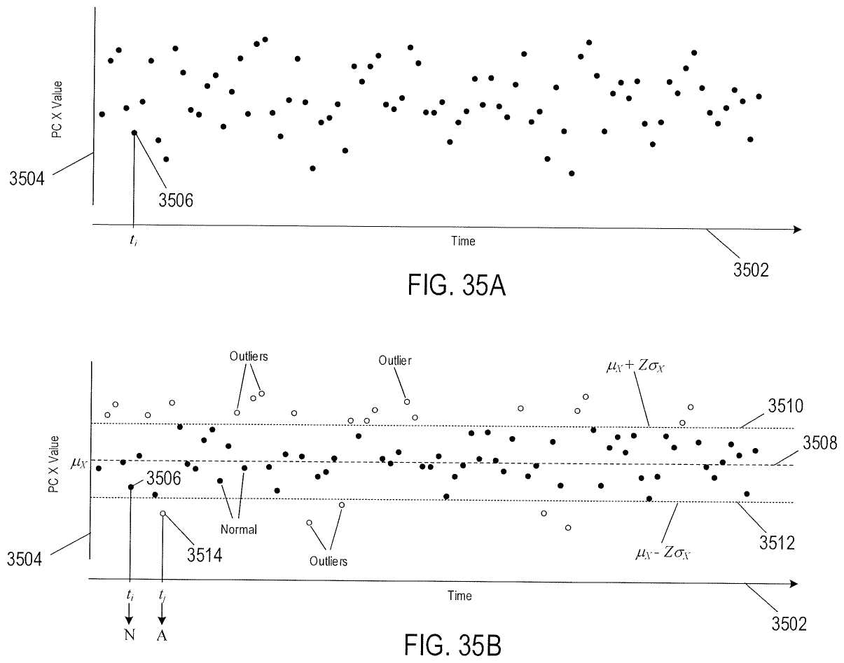

FIG. 35A shows a plot of an example system indicator over time. Horizontal axis 3502 represents a time interval. Vertical axis 3504 represents a range of system-indicator values. The system indicator may be principal-component average, principal-component average-absolute value, or principal-component distance. Each point represents system-indicator value at a time stamp computed according to one of Equations (19a)-(19c). For example, system-indicator value 3506 may represents the average of the principal-component values at the time stamp tᵢ according to Equation (19a).

System-indicator values are identified as normal or outliers based on whether the system-indicator values violate upper or lower normal bounds. An outlier system-indictor value is an indication of abnormal behavior of the complex computational system at a corresponding time stamp. Normal system-indicator values signify normal behavior by the object. The time stamp of a system-indicator value is labeled as normal if the following condition is satisfied:

μ_{X}−Zσ_{X}≤pc_{X}(tᵢ)≤μ_{X}+Zσ_{X} (20)

where
X denotes principal-component average value, principal-component average-absolute value, or principal-component distance;
Z is a number of standard deviations;

$${μ}_{X} = \frac{1}{N} {\sum }_{i = 1}^{N} p {c}_{X} ( {t}_{i} )$$

$${σ}_{X} = \sqrt{\frac{1}{N} {\sum }_{i = 1}^{N} {( p {c}_{X} ( {t}_{i} ) - {μ}_{X} )}^{2}}$$

$${μ}_{X} + Z {σ}_{X} is an upper normal bound ; and$$

$${μ}_{X} - Z {σ}_{X} is a lower normal bound .$$

Otherwise, if a system-indicator value does not satisfy the condition given by Equation (19) (i.e., violates the upper or lower normal bound), the system-indicator value is located outside the upper or lower normal bound and identified as an outlier and the corresponding time stamp is labeled abnormal.

FIG. 35B shows examples of normal and outlier system-indicator values for the example system indicator in FIG. 35A. Dashed line 3508 represents the average μ_{X} of the system-indicator values over the time interval. Dotted line 3510 represents an upper normal bound μ_{X}+Zσ_{X}. Dotted line 3512 represents a lower normal bound μ_{X}−Zσ_{X}. System-indicator values that are greater than the upper normal bound 3508 or are less than the lower normal bound 3510 are labeled as outlier system-indicator values, as represented by open dots. For example, open dots, such as open dot 3514, are labeled as outlier system-indicator values. System-indicator values located between the upper normal bound 3510 and the lower normal bound 3512 are labeled as normal system-indicator values, as represented by solid points, such as point 3506. The time stamps of normal system-indicator values are labeled normal. The time stamps of outlier system-indicator values are labeled abnormal. For example, system-indicator value 3514 is an outlier with a time stamp tⱼ that has been labeled “A” to denote abnormal behavior. System-indicator value 3506 is normal with a time stamp tᵢ that has been labeled “N” to denote normal behavior.

In another implementation, time series forecasting techniques are performed using a time-series model to construct upper and lower confidence intervals for a system indicator. The time-series models include an autoregressive (“AR”) model, an autoregressive moving average model (“ARMA”) model, or an autoregressive integrated moving average model (“ARIMA”). System indicator values located outside the upper and lower confidence bounds are identified as outliers. System indicator values located within the confidence intervals are identified as normal system indicator values.

The historical time window [t₁, t_{N}] may be partitioned into a historical interval [t₁, t_{K}] and a forecast interval (t_{K}, t_{N}], where K<N. Time series forecasting techniques compute forecast system-indicator values in the forecast interval based on system-indicator values in the historical interval. A system indictor that does not increase or decrease over the historical interval is called a non-trendy system indicator. Each system-indicator value may be considered as:

pc_{X}(tᵢ)=Aᵢ (21a)

where
i=1, . . . , N; and
Aᵢ is the stochastic amplitude of the system indicator.
   On the other hand, if the system indicator is a trendy, each system-indicator value may be decomposed as follows:

pc_{X}(tᵢ)=Tᵢ+Aᵢ (21b)

where Tᵢ is the trend component.

A trend estimate of the system indicator is computed in the historical time window. If the trend estimate does not adequately fit the system indicator over the historical time window, the system indicator is non-trendy. On the other hand, if the trend estimate fits the system indicator, the system indicator is trendy and the trend estimate is subtracted from the system indicator to obtain a detrended system indicator over the historical time window.

A linear trend estimate may be determined over the historical time window by a linear equation given by:

Tᵢ=α+βtᵢ (22a)

where
α is vertical axis intercept of the estimated trend; and
β is the slope of the estimated trend.
   The slope α and vertical axis intercept β of Equation (22a) may be determined by minimizing a weighted least squares equation given by:

$$L = {\sum }_{i = 1}^{N} {{w}_{i} ( p {c}_{X} ( {t}_{i} ) - α - β {t}_{i} )}^{2} \qquad ( 22 b )$$

where wᵢ is a normalized weight function.

Normalized weight functions wᵢ weight recent metric data values higher than older metric data values within the historical interval. Examples of normalized weight functions that give more weight to more recently received metric data values within the historical interval include wᵢ=e^{(i-N)} and wᵢ=i/N, for i=1, . . . , N. The slope parameter of Equation (22a) is computed as follows:

$$β = \frac{{\sum }_{i = 1}^{N} {w}_{t} ( {t}_{i} - {t}_{w} ) ( p {c}_{X} ( {t}_{i} ) - p {c}_{X} ( {t}_{w} ) )}{{\sum }_{i = 1}^{N} {{w}_{i} ( {t}_{i} - {t}_{w} )}^{2}} \qquad ( 22 c )$$

where

$${t}_{w} = \frac{{\sum }_{i = 1}^{N} {w}_{i} {t}_{i}}{{\sum }_{i = 1}^{N} {w}_{i}}$$

$${z}_{w} = \frac{{\sum }_{i = 1}^{N} {w}_{i} p {c}_{X} ( {t}_{i} )}{{\sum }_{i = 1}^{N} {w}_{i}}$$

The vertical axis intercept parameter of Equation (22a) is computed as follows:

α=z_{w}−βt_{w} (22d)

In other implementations, the weight function may be defined as wᵢ≡1.

A goodness-of-fit parameter is computed as a measure of how well the trend estimate fits the system-indicator values in the historical interval:

$${R}^{2} = \frac{{\sum }_{i = 1}^{N} {( {T}_{i} - p {c}_{X} ( {t}_{w} ) )}^{2}}{{\sum }_{i = 1}^{N} {( p {c}_{X} ( {t}_{i} ) - p {c}_{X} ( {t}_{w} ) )}^{2}} \qquad ( 23 )$$

The goodness-of-fit R² ranges between 0 and 1. The closer R² is to 1, the closer linear Equation (22a) is to providing an accurately estimate of a linear trend in the metric data of the historical interval. When R²≤Th_{trend}, where Th_{trend} is a user defined trend threshold less than 1, the estimated trend of Equation (22a) is not a good fit to the sequence of metric data values and the system indicator in the historical interval is regarded as non-trendy. On the other hand, when R²>Th_{trend}, the estimated trend of Equation (22a) is recognized as a good fit to the sequence of metric data in the historical interval and the trend estimate is subtracted from the metric data values. In other words, when R²>Th_{trend}, for i=1, . . . , N, the trend estimate of Equation (22a) is subtracted from the sequence of metric data in the historical interval to obtain detrended system-indicator values:

[symbol]

_{X}(tᵢ)=pc_{X}(tᵢ)−Tᵢ (24)

where the hat notation “\hat{ }” denotes non-trendy or detrended system-indicator values.

The sequence ( [symbol] _{X}(tᵢ))ᵢ₌₁^{N} is the detrended system indicator.

For the sake of convenience, in the following discussion, the term “system indicator” refers to a non-trendy system indicator or to a detrended system indicator and the term “system-indicator value” refers to a non-trendy system-indicator value or to a detrended system-indicator value. Likewise, the notation for a system-indicator value, pc_{X}(tᵢ), is used to represent a non-trendy system-indicator value, pc_{X}(tᵢ), or a detrended system-indicator value [symbol] _{X}(tᵢ).

The mean of the system indicator in the historical interval is given by:

$${μ}_{z} = \frac{1}{K} {\sum }_{i = 1}^{K} p {c}_{X} ( {t}_{i} )$$

When the system indicator has been detrended according to Equation (24) and R²>Th_{trend}, the mean μ_{z}≈0. On the other hand, when the system indicator satisfies the condition R²≤Th_{trend}, the mean μ_{z}≠0.

In alternative implementations, computation of the goodness-of-fit R² is omitted and the trend is computed according to Equations (22a)-(22d) followed by subtraction of the estimated trend from system indicator in the historical interval according to Equation (24). In this case, the mean μ_{z} is approximately zero in the discussion below.

The detrended system indicator may be stationary or non-stationary. A stationary system indicator comprises system-indicator values that vary over time in a stable manner about a fixed mean. On the other hand, the mean of a non-stationary system indicator is not fixed and varies over time.

The ARMA model may be applied to a stationary system indicator to forecast system-indicator values over a forecast interval. The ARMA model is represented, in general, by

ϕ(B)pc_{X}(t_{K})=θ(B)a_{K} (25a)

where
B is a backward shift operator;

$$φ ( B ) = 1 - {\sum }_{i = 1}^{p} {φ}_{i} {B}^{i}$$

$$θ ( B ) = 1 - {\sum }_{i = 1}^{q} {θ}_{i} {B}^{i}$$

a_{K} is white noise;
ϕᵢ is an i-th autoregressive weight parameter;
θᵢ is an i-th moving-average weight parameter;
p is the number of autoregressive terms called the “autoregressive order;” and
q is the number of moving-average terms called the “moving-average order;”
   The white noise is aₖ is a sequence of independent and identically distributed random variables with mean zero and variance σₐ². The backward shift operator is defined as Bpc_{X}(tₖ)=pc_{X}(t_{K-1}) and Bⁱpc_{X}(t_{K})=pc_{X}(t_{K-i}). In expanded notation, the ARMA model of Equation (25a) is represented by

$$p {c}_{X} ( {t}_{K} ) = {\sum }_{i = 1}^{p} {φ}_{i} {pc}_{X} ( {t}_{K - i} ) + {a}_{K} + {μ}_{z} Φ + {\sum }_{i = 1}^{q} {θ}_{i} {a}_{K - i} \\ where Φ = 1 - {φ}_{1} - … - {φ}_{p} . \qquad ( 25 b )$$

The white noise parameters aₖ may be determined at each time stamp by randomly selecting a value from a fixed normal distribution with mean zero and non-zero variance. The autoregressive weight parameters are computed from the matrix equation:

[symbol]

=P⁻¹ [symbol] (26)

where

$$\vec{φ} = [ \begin{matrix}{φ}_{1} \\ ⋮ \\ {φ}_{p}\end{matrix} ] ;$$

$$\vec{ρ} = [ \begin{matrix}{ρ}_{1} \\ ⋮ \\ {ρ}_{p}\end{matrix} ] ; and$$

$${P}^{- 1} = {[ \begin{matrix}1 & {ρ}_{1} & … & {ρ}_{p - 1} \\ {ρ}_{1} & 1 & … & {ρ}_{p - 2} \\ ⋮ & ⋮ & ⋱ & ⋮ \\ {ρ}_{p - 1} & {ρ}_{p - 2} & … & 1\end{matrix} ]}^{- 1}$$

The matrix elements are computed from the autocorrelation function given by:

$${ρ}_{k} = \frac{{γ}_{k}}{{γ}_{0}} \\ where \\ {γ}_{k} = \frac{1}{K} {\sum }_{i = 1}^{K - k} ( p {c}_{X} ( {t}_{i} ) - {μ}_{z} ) ( p {c}_{X} ( {t}_{i + k} ) - {μ}_{z} ) \\ {γ}_{0} = \frac{1}{K} {\sum }_{i = 1}^{K} {( {pc}_{X} ( {t}_{i} ) - {μ}_{z} )}^{2} \qquad ( 27 )$$

The moving-average weight parameters, θᵢ, may be computed using gradient descent.

The ARMA model may be used to compute forecast system-indicator values in a forecast interval as:

$${X}_{} ( {t}_{K + l} ) = {\sum }_{t = 1}^{l - 1} {φ}_{i} {X}_{} ( {t}_{K + l - i} ) + {\sum }_{i = l}^{p} {φ}_{i} p {c}_{X} ( {t}_{K + l - i} ) + {a}_{K + l} + {μ}_{z} Φ + {\sum }_{i = 1}^{q} {θ}_{i} {a}_{K + l - i} \qquad ( 28 )$$

wherein
l=1, . . . , L is a lead time index with L the number of lead time stamps in the forecast interval;
“˜” denotes a forecast system-indicator value;
[symbol] _{X}(t_{K}) is zero; and
a_{K+l} is the white noise for the lead time stamp t_{K+l}.

In other implementations, an autoregressive process (“AR”) model given by:

$$p {c}_{X} ( {t}_{K} ) = {\sum }_{i = 1}^{p} {Φ}_{i} {pc}_{X} ( {t}_{K - i} ) + {α}_{K} + {μ}_{z} Φ \qquad ( 29 )$$

The AR model is obtained by omitting the moving-average weight parameters form the ARMA model. By omitting the moving-average model, computation of the autoregressive weight parameters of the autoregressive model is less computationally expensive than computing the autoregressive and moving-average weight parameters of the ARMA models. Forecast system-indicator values may be computed using Equation (28) with the moving-average weight parameters set to zero.

Unlike a stationary system indicator, a non-stationary system indicator does not vary over time in a stable manner about a fixed mean. In other words, a non-stationary system indicator behaves as the though the system-indicator values have no fixed mean. In these situations, an ARIMA model may be used to forecast system-indicator values. The ARIMA model is given by:

ϕ(B)∇^{d}pc_{X}(t_{K})=θ(B)a_{K} (30)

where ∇^{d}=(1−B)^{d}.

The ARIMA autoregressive weight parameters and move-average weight parameters are computed in the same manner as the parameters of the ARMA models described above in Equation (25a).

When the system indicator has been identified as trendy, as described above with reference to Equations (22a)-(22d), the estimated trend may be added to the forecast system-indicator values at time stamps in the forecast interval to obtain forecast system-indicator values with the estimated trend given by T_{K}+ [symbol] _{X}(t_{K+l}).

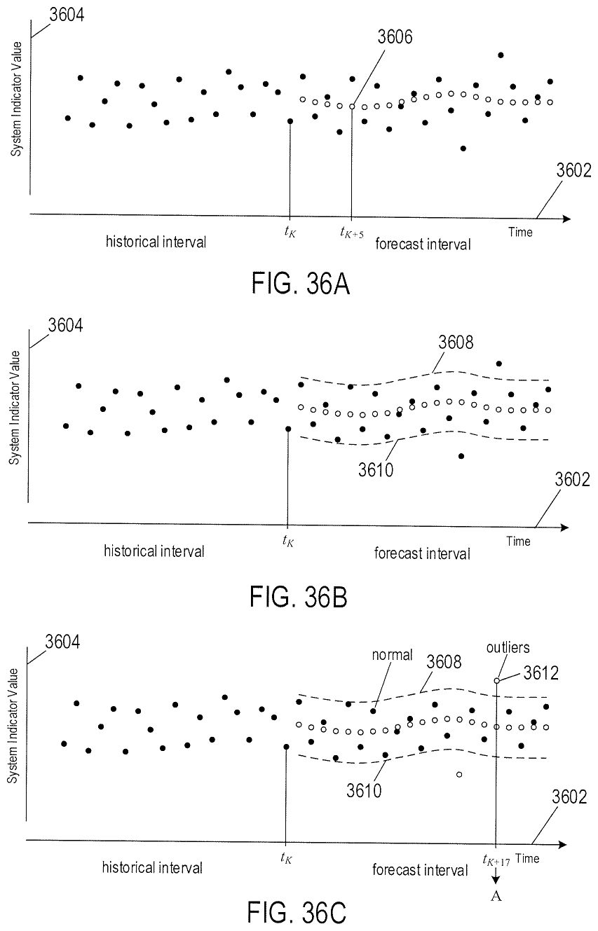

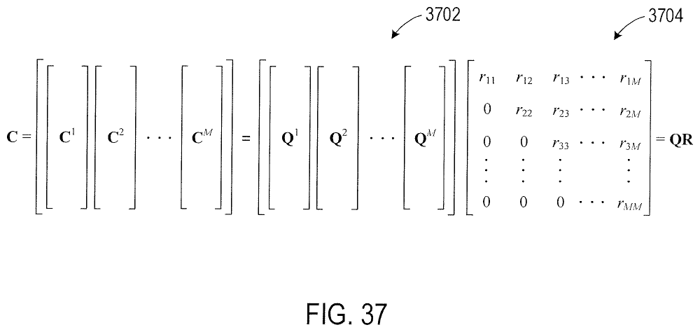

FIG. 36A shows a plot of an example system indicator and forecast system-indicator values. Horizontal axis 3602 represents time. Vertical axis 3604 represents a range of system-indicator values. Dark shaded points represent system-indicator values computed as described above with reference to one of Equations (19a)-(19c). The time axis 3602 represents the historical time window divided into a historical interval and a forecast interval at a time stamp t_{K}. System-indicator values with time stamps less than or equal to the time stamp t_{K} are used to compute forecast system-indicator values, using an AR, ARMA, or an ARIMA as described above, at time stamps greater than t_{K}. Lighter shaded points represent forecast system-indicator values. For example, lighter shaded point 3606 [symbol] _{K}(t_{K+5}) represents a forecast system-indicator value at the time stamp t_{K+5}.

Upper and/or lower confidence bounds are computed over the forecast interval and are used to identify outlier system-indicator values in the forecast interval. Upper confidence values of the upper and/or lower confidence bounds are computed at time stamps in the forecast interval by

uc_{K+l}=pc_{X}(t_{K+l})+Cσ(l) (31a)

and lower confidence values may also be computed at time stamps in the forecast interval by

lc_{K+l}=pc_{X}(t_{K+l})−Cσ(l) (31b)

where
C is a prediction interval coefficient; and
σ(l) is an estimated standard deviation of the l-th lead time stamp in the forecast interval.

The upper and lower confidence values define a confidence interval denoted by [lc_{K+l},uc_{K+l}]. The prediction interval coefficient C corresponds to a probability that a system-indicator value will lie in the confidence interval [lc_{K+l}, uc_{K+l}]. Examples of prediction interval coefficients are provided in the following table:

| Coefficient (C) | Percentage (%) |
|---|---|
| 2.58 | 99 |
| 1.96 | 95 |
| 1.64 | 90 |
| 1.44 | 85 |
| 1.28 | 80 |
| 0.67 | 50 |

For example, a 95% confidence gives a confidence interval [ [symbol] _{X}(t_{K+l})−1.96σ(l), [symbol] _{X}(t_{K+l})+1.96σ(l)]. In other words, there is a 95% chance that the K+l-th forecast system-indicator value will lie within the confidence interval based on the system-indicator values in the historical interval.

The estimated standard deviation σ(l) in Equations (31a)-(31b) is given by:

$$σ ( l ) = \sqrt{{σ}_{a}^{2} {\sum }_{j = 1}^{l - 1} {ψ}_{j}^{2}} \qquad ( 32 )$$

where the ψⱼ's are the weights.

When forecasting is executed using an AR model, the weights of Equation (32) are computed recursively as follows:

$${ψ}_{j} = {\sum }_{i = 1}^{p} {φ}_{i} {ψ}_{j - i} \qquad ( 33 a )$$

where ψ₀=1.

When forecasting is executed using an ARMA model, the weights of Equation (32) are computed recursively as follows:

$${ψ}_{j} = {\sum }_{i = 1}^{p} {φ}_{i} {ψ}_{j - i} - {θ}_{j} \qquad ( 33 b )$$

where θⱼ=0 for j>q.

When forecasting is executed using an ARIMA model, the weights of Equation (32) are computed recursively as follows:

$${ψ}_{j} = {\sum }_{i = 1}^{p + d} {φ}_{i} {ψ}_{j - i} - {θ}_{j} \qquad ( 33 c )$$

FIG. 36B shows confidence bounds for the forecast system indicator over the forecast interval shown in FIG. 36A. Dashed curve 3608 represents upper confidence bounds, and dashed curve 3610 represents lower confidence bounds. FIG. 36C shows outlier system-indicator values identified by open points. The time stamps of outlier system-indicator values are labeled abnormal. For example, forecast system-indicator value 3612 is an outlier with a time stamp t_{K+17} that has been labeled abnormal “A.”

### Discarding Correlated Metrics

Because correlated metrics are not independent and may contain redundant information, processes and systems further reduce the number of metrics by identifying and discarding correlated metrics. Processes and systems use QR decomposition of the deviation matrix to determine the uncorrelated metrics. A numerical rank of the deviation matrix is determined from the eigenvalues of the deviation matrix based on a tolerance, τ, where 0<τ≤1. For example, the tolerance τ may be in an interval 0.8≤τ≤1. Consider the rank-ordered eigenvalues, {λₖ^{ro}}ₖ₌₁^{M}, computed for the correlation matrix 2102 as described above. The rank-ordered eigenvalues of the deviation matrix are positive values. The accumulated impact of the eigenvalues is determined based on the tolerance τ according to the following two conditions:

$$\begin{matrix}\frac{{λ}_{1}^{r o} + … + {λ}_{m - 1}^{r o}}{M} < τ & ( 34 a ) \\ \frac{{λ}_{1}^{ro} + … + {λ}_{m - 1}^{r o} + {λ}_{m}^{r o}}{M} \geq τ & ( 34 b )\end{matrix}$$

where m is the numerical rank of the correlation matrix.

In other words, Equations (34a) and (34b) determine the smallest number m of eigenvalues with an accumulated impact. The numerical rank m indicates that the metrics {uⱼ}ⱼ₌₁^{M} have m independent (i.e., uncorrelated) metrics and M−m correlated metrics.

Given the numerical rank m, the m independent metrics may be determined using QR decomposition of the deviation matrix. In particular, the m independent (i.e., uncorrelated) metrics are determined based on the m largest diagonal elements of an upper diagonal R matrix obtained from QR decomposition of the deviation matrix.

FIG. 37 illustrates QR decomposition of the deviation matrix. The M columns of the deviation matrix are denoted by C¹, C², . . . , C^{M}, M columns of a Q matrix 3702 are denoted by Q¹, Q², . . . , Q^{M}, and M diagonal elements of the upper diagonal R matrix 3704 are denoted by r₁₁, r₂₂, . . . , r_{MM}. The columns of the Q matrix 3702 are determined based on the columns of the deviation matrix as follows:

$${Q}^{i} = \frac{{U}^{i}}{‖ {U}^{i} ‖} \qquad ( 35 a )$$

where
∥Uⁱ∥ denotes the length of a vector Uⁱ; and
the vectors Uⁱ are calculated according to

$$\begin{matrix}{U}^{1} = {C}^{1} & ( 35 b ) \\ {U}^{i} = {C}^{i} - {\sum }_{j = 1}^{i - 1} \frac{〈 {Q}^{1} , {C}^{j} 〉}{〈 {Q}^{j} , {Q}^{j} 〉} {Q}^{j} & ( 35 c )\end{matrix}$$

where [symbol] ⋅,⋅ [symbol] denotes the scalar product.

The diagonal matrix elements of the R matrix are given by

rᵢᵢ= [symbol] Qⁱ,Cⁱ [symbol] (35d)

The diagonal matrix elements of the upper diagonal matrix R are rank ordered. The metrics that correspond to the largest m (i.e., numerical rank) diagonal elements of the matrix R are uncorrelated. For example, suppose C^{k}=[cor(ū₁, ūₖ), cor(ū₂, ūₖ), . . . , cor(ū_{M}, ūₖ)]^{T} corresponds to an upper diagonal element rₖₖ that is among the m largest diagonal elements of the matrix R. The mean-centered metric ūₖ is uncorrelated with other mean centered metrics in the set of mean-centered metrics {ūⱼ}ⱼ₌₁^{M}. Likewise, the corresponding metric uₖ is not correlated with metrics in the set of metrics {ūⱼ}ⱼ₌₁^{M}. The uncorrelated metrics are represented in set notation by

$${\{ {\hat{u}}_{k} , ( t ) \}}_{k = 1}^{m} = {\{ {( {x}_{i}^{( k )} )}_{i = 1}^{N} \}}_{k = 1}^{m} = {\{ {( {x}^{( k )} ( {t}_{i} ) )}_{i = 1}^{N} \}}_{k = 1}^{m} \qquad ( 36 )$$

where k is the index of the metrics that are uncorrelated, synchronized, and have acceptable variation over time, where m≤M.

### Generate Rules for Identifying Abnormal Complex Computational System Performance and Execute Remedial Measures

Processes and systems compute rules for detecting abnormal behavior of the complex computational system associated with the uncorrelated metrics {ûₖ(t)}ₖ₌₁^{m} using a decision tree technique such as one or the decision tree techniques, such as iterative dichotomiser 3 (“ID3”) decision tree learning, C4.5 decision tree learning, and C5.0 boot strapping decision tree learning. The outlier time stamps and the uncorrelated metrics {ûₖ(t)}ₖ₌₁^{m} are input to the decision tree technique, which uses machine learning to generate rules that are used to identify abnormal behavior of the complex computational system.

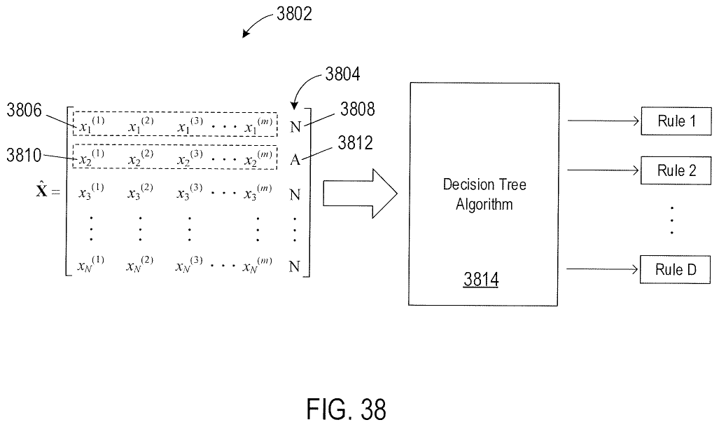

FIG. 38 shows an example of a decision tree technique used to generate rules based on the uncorrelated metrics {ûₖ(t)}ₖ₌₁^{m}. The uncorrelated metrics {ûₖ(t)}ₖ₌₁^{m} are represented by a matrix \hat{X} 3802. Each column of the matrix X̅ 3802 comprises the metric values of a metric in the uncorrelated metrics {ûₖ(t)}ₖ₌₁^{m}. Column 3804 contains the normal and abnormal labels of the time stamps, as described above with reference to FIGS. 33A-36C. For example, row 3806 contains metrics values of the metrics in the uncorrelated metrics {ûₖ(t)}ₖ₌₁^{m} at the time stamp t₁ when the complex computational system exhibited normal behavior as indicated by label “N” 3808. On the other hand, row 3810 contains metrics values of the metrics in the uncorrelated metrics {ûₖ(t)}ₖ₌₁^{m} at the time stamp t₂ when the complex computational system exhibited abnormal behavior as indicated by label “A” 3812. Block 3814 represents the computation operations carried out by the decision tree technique. As shown in FIG. 38, the m metrics and labels are input to the decision tree technique to generate D rules. Each rule is an abnormal classification of the complex computational system behavior. A rule may be associated with a single metric, or a rule may be associated with numerous metrics. Violation of a particular rule may be an indication of a particular type of abnormal state of the complex computational system. Depending on the type of rule violation, processes and systems may generate an alert identifying the abnormal state of the object. The rules obtained by the decision tree technique in FIG. 38 may be used to identify abnormal behavior of the complex computational system in run-time metric values of the uncorrelated metrics {ûₖ(t)}ₖ₌₁^{m} used to construct the rules using the decision tree technique.

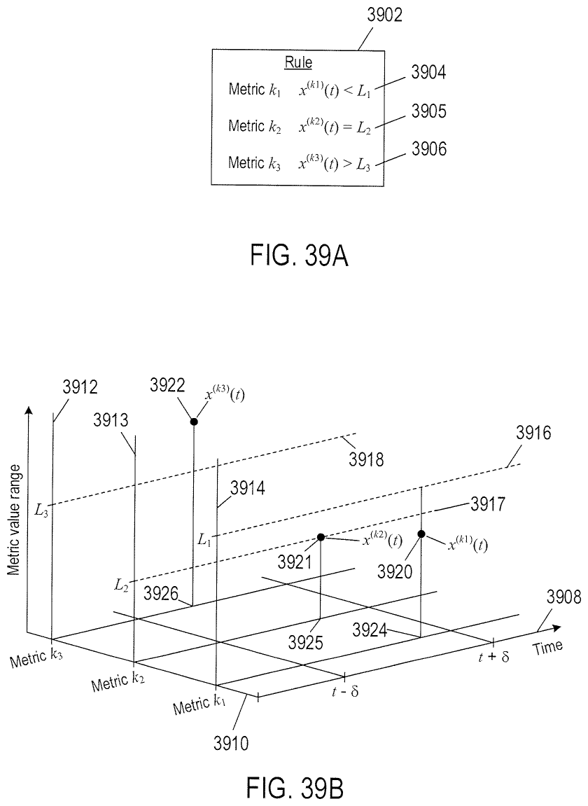

FIGS. 39A-39B show an example of a rule 3902 associated with three uncorrelated metrics. In FIG. 39A, the rule 3902 comprises three conditions 3904-3906 for three uncorrelated metrics denoted by k1, k2, and k3. The conditions have corresponding thresholds L₁, L₂, and L₃ associated with three metrics x^{(k1)}, x^{(k2)} and x^{(k3)}. In one implementation, the metrics may be time synchronized to a general set of uniformly spaced time stamps, as described above with reference to FIG. 16B. When synchronized run-time metric values x^{(k1)}(t), x^{(k2)}(t), and x^{(k3)}(t) satisfy the three conditions 3904-3906, respectively, the rule is violated and an alert is generated identifying the abnormal behavior of complex computational system.

In an alternative implementation, the run-time metrics may be unsynchronized. When run-time metric values x^{(k1)}(t), x^{(k2)}(t), and x^{(k3)}(t) satisfy the three conditions 3904-3906, respectively, for corresponding time stamps located in an interval [t−δ, t+δ], the rule is violated and an alert is generated identifying the abnormal behavior of complex computational system. Note that the time stamp t in the run-time metric values x^{(k1)}(t), x^{(k2)}(t), and x^{(k3)}(t) is not intended to imply that the metric values have the same time stamp. The run-time metric values x^{(k1)}(t), x^{(k2)}(t), and x^{(k3)}(t) may have been generated by different metric sources at different time stamps. The value of S may be selected so that the interval [t−δ, t+δ] covers a range of time stamps of the run-time metric values x^{(k1)}(t), x^{(k2)}(t), and x^{(k3)}(t). FIG. 39B shows a plot of run-time metric values x^{(k1)}(t), x^{(k2)}(t), and x^{(k3)}(t) that satisfy the three conditions 3904-3906 and have different time stamps in an interval [t−δ, t+δ]. Axis 3908 represents time. Axis 3910 represents the metrics k1, k2, and k3. Vertical axes 3912-3914 represent the ranges of for the metric values. Dashed lines 3916-3918 represent the thresholds L₁, L₂, and L₃. Solid points 3920-3922 represent metric values x^{(k1)}(t), x^{(k2)}(t), and x^{(k3)}(t) that violate the rule 3902 with time stamps 3924-3926 in the time interval [t−δ, t+δ], thereby triggering an alert is generated identifying the abnormal behavior of complex computational system.

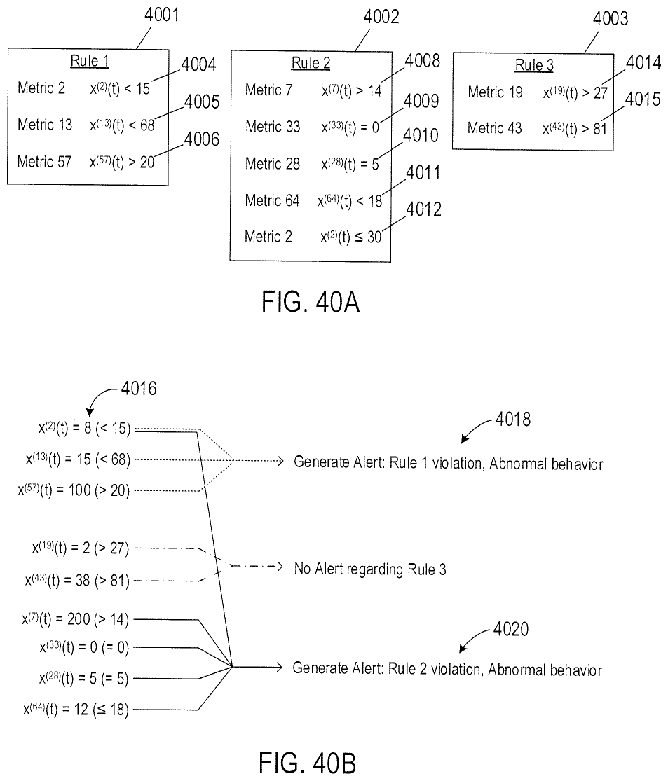

FIG. 40A shows three example rules output from the decision tree technique described above with reference to FIG. 38. The three example rules are identified as Rule 1 4001, Rule 2 4002, and Rule 3 4003. Rule 1 comprises three conditions 4004-4006 regarding run-time metric values for metrics 6, metric 11, and metric 68. When the three conditions 4004-4006 are satisfied for the three run-time metric values of corresponding metric 2, metric 13, and metric 57 at approximately the same time stamp, Rule 1 is violated and an alert is generated indicating the complex computational system is behaving abnormally due to a Rule 1 violation. Rule 2 comprises five conditions 4008-4012 regarding run-time metric values for metric 7, metric 33, metric 28, metric 64, and metric 2. When the conditions 4008-4012 are satisfied for run-time metric values of corresponding metrics 7, 33, 28, 64, and 2, Rule 2 have violated and an alert is generated indicating the complex computational system is behaving abnormally due to a Rule 2 violation. Rule 3 comprises two conditions 4014 and 4015 regarding run-time metric values for metric 19 and metric 43. When the two conditions 4014 and 4015 are satisfied for two run-time metric values of the corresponding metrics 19 and 43 at about the same time stamp, Rule 3 is violated and an alert is generated indicating the complex computational system is behaving abnormally due to a Rule 3 violation.

FIG. 40B shows an example of the rules Rule 1, 2, and 3 applied to run-time metric data generated by uncorrelated metrics 2, 7, 13, 19, 28, 33, 43, 57, and 64. FIG. 40B shows examples of run-time metric values 4016 for each of the metrics 2, 7, 13, 19, 28, 33, 43, 57, and 64 generated at approximately the same time stamp t. For example, x⁽²⁾(t)=8 is the metric value for the metric 6 generated at the time stamp t. The conditions for the rules are displayed next to each of the run-time metric values. According to Rule 1 in FIG. 40A, the metric values x⁽²⁾(t)=8, x⁽¹³⁾(t)=11, and x⁽⁵⁷⁾(t)=100 satisfy the three conditions for a Rule 1 violation, which triggers an alert 4018. The example of FIG. 40B reveals that the run-time metric values x⁽¹⁹⁾(t)=2 and x⁽⁴³⁾(t)=38 of metrics 19 and 43 do not violate Rule 3, which does not trigger an alert. The run-time metric values x⁽²⁾(t)=8, x⁽⁷⁾(t)=200, x⁽³³⁾(t)=0, x⁽²⁸⁾(t)=5, and x⁽⁶⁴⁾(t)=12 for metrics 2, 7, 33, 28, and 64 violate Rule 2, which triggers an alert 4020. The alerts may be generated on an administration console to notify IT administrators of the abnormal behavior of the object.

Given the many different types of abnormal states of complex computational systems, IT administrators may have developed different remedial measures for correcting the various different abnormal states. Processes and systems identify a rule violation that triggers an alert identifying the abnormal state of the complex computational system and may also generate instructions for correcting the abnormality or execute preprogrammed computer instructions that correct the abnormality. For example, if an object is a virtual object and an alert is generated indicating inadequate virtual processor capacity, remedial measures that increase the virtual processor capacity of the virtual object may be executed or the virtual object may be migrated to a different server computer with more available processing capacity.

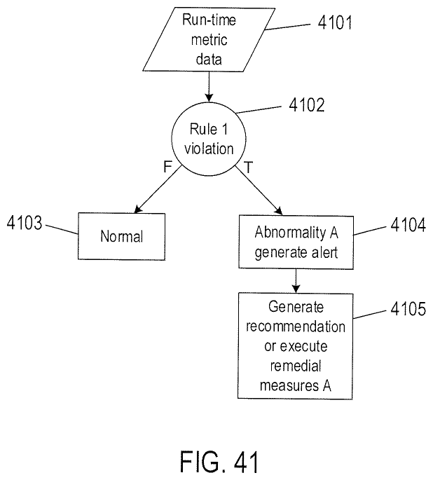

FIG. 41 shows an example graph of operations executed in response to a rule violation. Nodes represent a run-time metric value, Rule 1, and operations that are executed if Rule 1 is violated. Directional arrows represent directed edges that represent the relationships between nodes. Truth values are represented by T and F and are used to represent whether the rule has been violated, as described above with reference to FIGS. 40A-40B. Node 4101 represents run-time or newly identified metric value. Node 4102 represents violation of Rule 1. Node 4103 represents normal operation of the resource. If Rule 1 is violated, node 4104 represents generating an alert that identifies the type of rule violation, denoted by Abnormality A. For example, Abnormality A may represent an excessive error rate. Node 4105 represents generating a recommended remedial measure A that corrects Abnormality A or automatically executes remedial measure A.

In other instances, certain abnormal behaviors may be identified by a combination of two or more rule violations. Each combination of rule violations may have different associated remedial measures for correcting the problem. For example, a computer server that has become compute bound may be identified when rules associated with CPU response time and memory usage are violated. A single alert may be generated indicating the server computer has become compute bound. Remedial measures may include restarting the server computer or migrating virtual objects to other server computers in order to reduce the workload at the server computer.

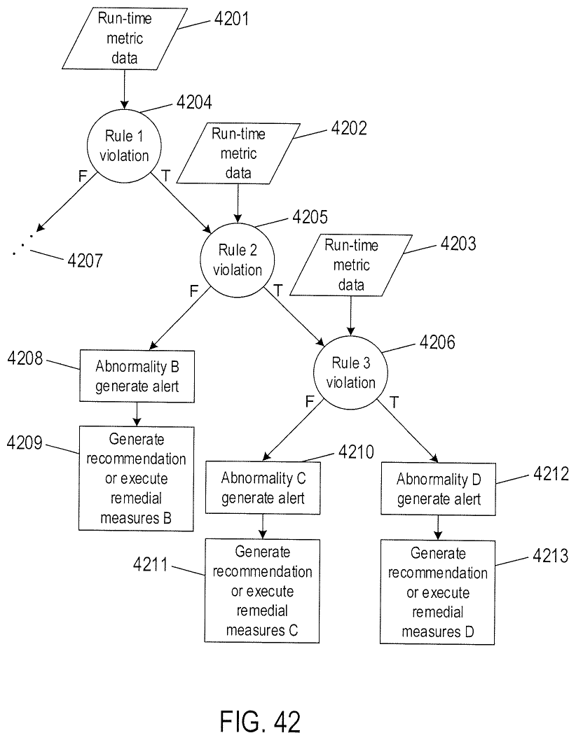

FIG. 42 shows an example graph of operations that may be executed in response to different combinations of rule violations. Nodes 4201-4203 represents run-time metrics values for the metrics. Nodes 4204-4206 represent rules denoted by Rule 1, Rule 2, and Rule 3. Ellipsis 4207 represents other nodes of the graph not shown. Nodes 4208, 4210, and 4212 represent three different types of alerts associated with three different types of abnormalities identified as Abnormality B, Abnormality C, and Abnormality D. For example, Abnormality B may represent excessive virtual CPU usage, Abnormality C may represent a combination of excessive virtual CPU and virtual memory usage, and Abnormality D may represent a combination of excessive virtual CPU usage, virtual memory usage, and virtual data storage usage. Nodes 4209, 4211, and 4213 represent three different types of remedial measures identified as remedial measure B, remedial measure C, and remedial measure D. For example, remedial measure B may represent increasing virtual CPU, remedial measure C may represent increasing virtual CPU and virtual memory, and remedial measure D may represent migrating the virtual object to a different server computer. As shown in FIG. 42, if Rule 1 is violated and Rule 2 is not violated, node 4208 generates an alert identifying abnormality B. Node 4209 generates recommended remedial measure B or automatically executes remedial measure B. If Rules 1 and 2 are violated and Rule 3 is not violated, node 4210 generates an alert identifying Abnormality C. Node 4211 generates recommended remedial measure C or automatically executes remedial measure C. If Rules 1, 2, and 3 are violated, node 4212 generates an alert identifying Abnormality D. Node 4213 generates recommended remedial measure D or automatically executes the remedial measures D.

In certain cases, when one of the run-time system indicators is identified as an outlier, an alert may be triggered indicating that the complex computational system is in an abnormal state. In other case, when a subsequence of the run-time metric values is identified as an outlier (e.g., a subsequence of five or more system indicators are outliers), the complex computational system is in an abnormal state. When a complex computational system enters an abnormal state, an alert is triggered. For example, the alert may be displayed in a graphical user interface of a system administration console. The alert may identify the complex computational system and the abnormality. For example, if a complex computational system is a number of VMs and an alert is triggered, the VMs may be torn down, resources, such CPU and memory, may be increased, or the VMs may be migrated to different server computers with more available memory and processing capacity. As another example, if the complex computational system is a cluster of server computers, remedial measures may include restarting the server computers or migrating virtual objects running on the cluster to other cluster of server computers, or the cluster of server computers may be taken off line or shut down.

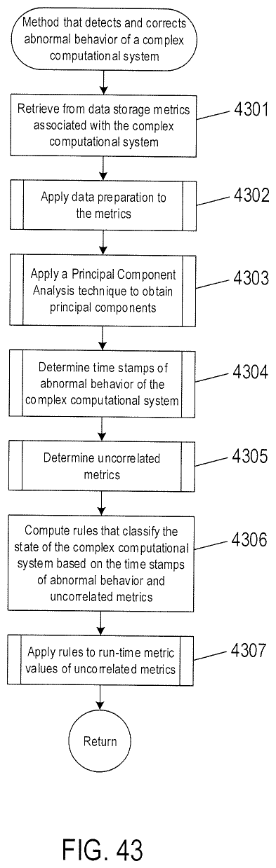

The methods described below with reference to FIGS. 43-51 are stored in one or more data-storage devices as machine-readable instructions that when executed by one or more processors of the computer system shown in FIG. 1 detect abnormal behavior of a complex computational system of a distributed computing system.

FIG. 43 is a flow diagram illustrating an example implementation a method that detects and corrects abnormal performance of a complex computational system of a distributed computing system. In block 4301, metrics associated with the complex computational system over an historical time window are retrieved from data storage. In block 4302 an “apply data preparation to the metrics” procedure is performed to discard constant and nearly constant metrics from the metrics. In block 4303 an “apply PCA technique to obtain principal components” procedure is performed to determine principal components of the non-constant metrics. In block 4304 a “determine time stamps of abnormal behavior of the complex computational system” procedure is performed to determine time stamps of abnormal behavior of the complex computational system over a historical time window. In block 4305 a “determine uncorrelated metrics” procedure is performed. In block 4306 rules that classify the state of the complex computational system are computed based on the time stamps of abnormal behavior and uncorrelated metrics as described above with reference to FIG. 38. In block 4307 an “apply rules to run-time metric values of the uncorrelated metrics” procedure is performed to determine whether the complex computational system is in an abnormal state.

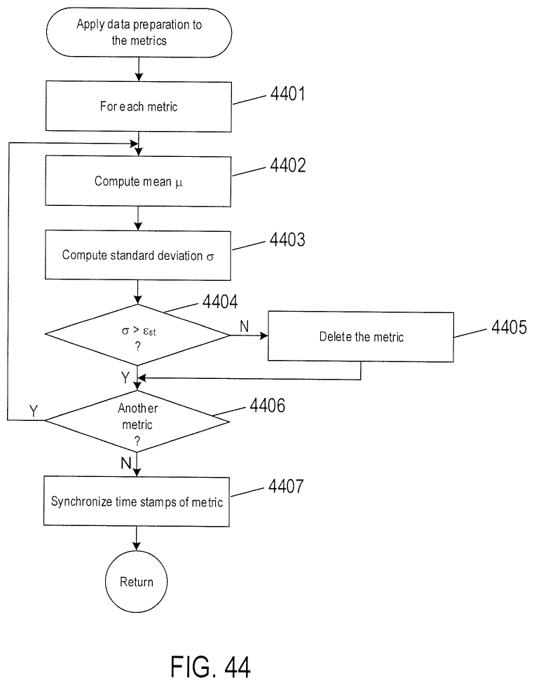

FIG. 44 is a flow diagram illustrating an example implementation of the “apply data preparation to the metrics” step referred to in block 4302 of FIG. 43. A loop beginning with block 4301 repeats the operations represented by blocks 4302-4306 for each metric associated with the object. In block 4302, a mean is computed for the metric. In block 4303, a standard deviation is computed based on the metric and the mean computed in block 4302. In block 4304, when the standard deviation is less than a standard deviation threshold, control flows to block 4305. In block 4305, the metric is deleted from the metrics and not used below. In block 4306, the operations represented by blocks 4302-4305 are repeated for another metric. In block 4307, each metric is synchronized to a general set of uniformly spaced time stamps, as described above with reference to FIG. 16B.

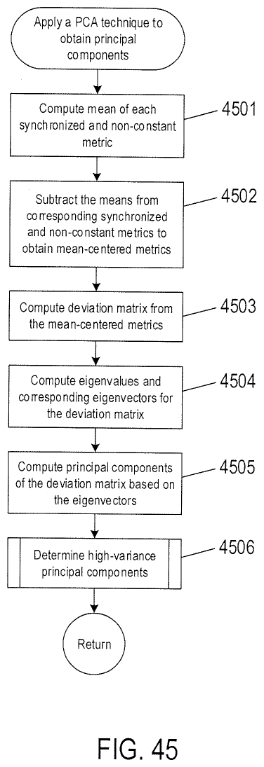

FIG. 45 is a flow diagram of an example implementation of the “apply a PCA technique to obtain principal components” step referred to in block 4303 of FIG. 43. In block 4501, compute a mean of each synchronized and non-constant metric as described above with reference to Equation (3b). In block 4502, subtract the means from corresponding synchronized and non-constant metrics to obtain mean-centered metrics as described above with reference Equation (5). In block 4503, a deviation matrix is computed from the mean-centered metrics as described above with reference to FIGS. 21A-21C and Equations (6a) or (6b). In block 4504, eigenvalues and corresponding eigenvectors are computed as described above with reference to FIG. 22 and Equations (8) and (9). In block 4505, principal components of the deviation matrix are computed based on the eigenvectors as described above with reference to Equation (11) and FIGS. 24 and 26. In block 4506, a “determine high-variance principal component” procedure is performed on the principal components obtained in block 4505.

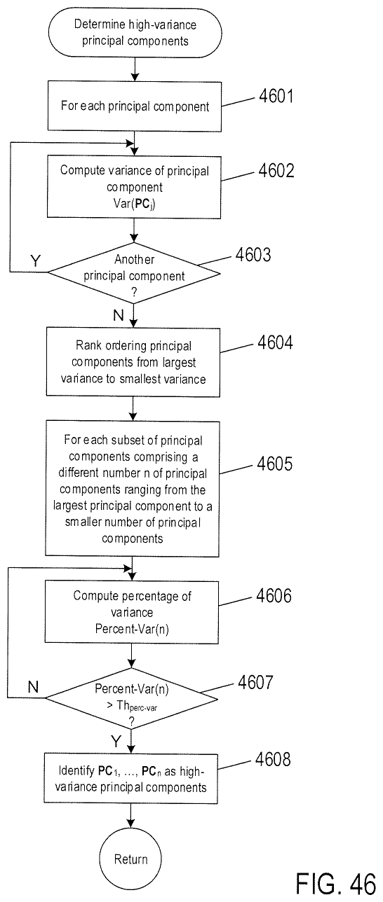

FIG. 46 is a flow diagram of an example implementation of the “determine high-variance principal component” step referred to in block 4506 of FIG. 45. A loop beginning with block 4601 repeats the computational operation represented by block 4602 for each principal component. In block 4602, a variance of the principal component is computed as described above with reference to Equation (12). In decision block 4603, when the variance of each principal component has been computed, control flows to block 4604. In block 4604, the principal components are rank order from the largest variance to the smallest variance as described above with reference FIG. 29. A loop beginning with block 4605 repeats the computational operation represented by block 4606 for each subset of principal components comprising a different number n of principal components with the n largest variances (e.g., discussion of FIG. 30). In block 3706, a percentage of variance is computed for each subset of principal components as described above with reference to Equation (13). In decision block 4607, when the smallest percentage of variance satisfies the condition given by Equation (14), control flows to block 4608. In block 4608, the principal components with a percentage of variance that satisfies the condition in decision block 4607 are identified as high-variance principal components.

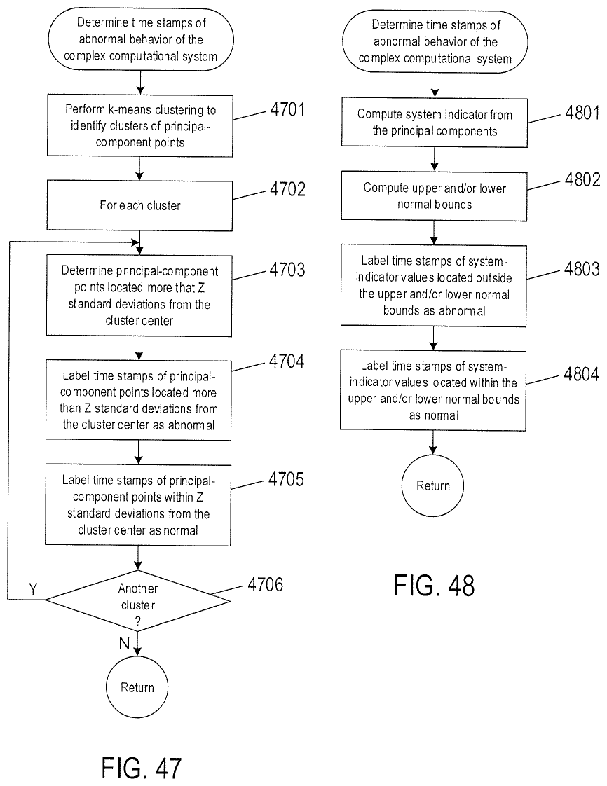

FIG. 47 is a flow diagram of a first example implementation of the “determine time stamps of abnormal behavior of the complex computational system” step referred to in block 4304 of FIG. 43. In block 4701, a system indicator is computed from the principal components, as described above with reference to FIGS. 33A-33D and Equations (15) and (16). A loop beginning with block 4702 repeats the computational operations represented by blocks 4703-4705 for each cluster. In block 4703, principal component points located more than Z standard deviations from the cluster center are determined, as described above with reference to Equation (18) and FIG. 34. In block 4704, time stamps of principal-component points located more than Z standard deviations from the cluster center are labeled abnormal, as described above with reference to FIG. 34. In block 4705, time stamps of principal-component points within Z standard deviations from the cluster center are labeled normal, as described above with reference to FIG. 34. In decision block 4706, blocks 4703-4705 are repeated for another cluster.

FIG. 48 is a flow diagram of a second example implementation of the “determine time stamps of abnormal behavior of the complex computational system” step referred to in block 4304 of FIG. 43. In block 4801, a system indicator is computed from the principal components as described above with reference to one or Equations (19a)-(19c). In block 4802, upper and/or lower normal bounds are computed as described above with reference to Equation (20). In block 4803, time stamps principal-component points located outside the upper and/or lower normal bounds are labeled as abnormal, as described above with reference to Equation (18) and FIG. 35B. In block 4804, time stamps principal-component points located within the upper and/or lower normal bounds are labeled as normal, as described above with reference to Equation (18) and FIG. 35B.

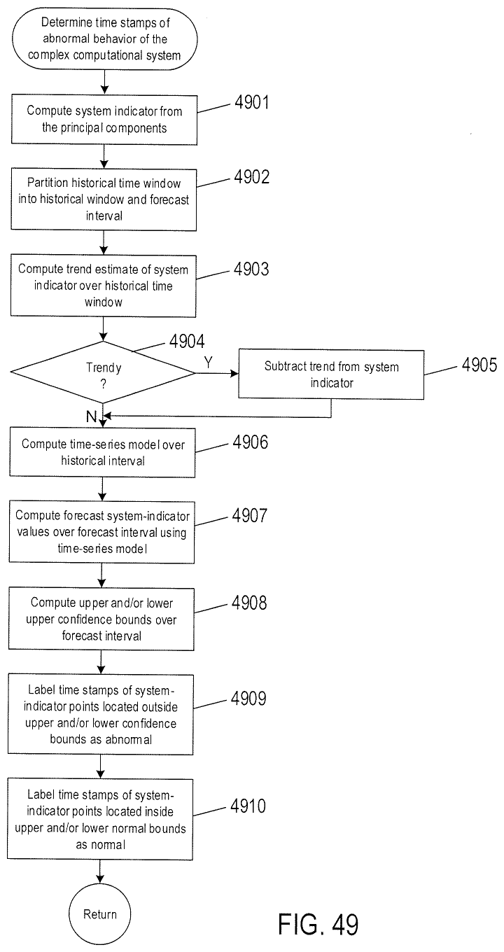

FIG. 49 is a flow diagram of a third example implementation of the “determine time stamps of abnormal behavior of the complex computational system” step referred to in block 4304 of FIG. 43. In block 4901, a system indicator is computed from the principal components as described above with reference to one or Equations (19a)-(19c). In block 4902, a historical time window is partitioned in a historical interval and a forecast interval, as described above with reference to FIG. 36A. In block 4903, a trend estimate is computed over the historical time window as described above with reference to Equations (22a)-(22d). In decision block 4904, if the system indicator is trendy as described above with reference to the goodness-of-fit in Equation (23), control flows to block 4905. Otherwise, control flows to block 4906. In block 4905, the trend is subtracted from the system indicator, as described above with reference to Equation (24). In block 4906, a time-series model is computed over the historical interval. In block 4907, forecast system-indicator values are computed over the forecast interval using the time-series model, as described above with reference to Equations (25)-(30). In block 4908, upper and/or lower confidence bounds are computed over the forecast interval, as described above with reference to FIG. 36B and Equations (31a)-(31b). In block 4909, time stamps of system-indicator values located outside the upper and/or lower confidence bounds are labeled as abnormal, as described above with reference to FIG. 36C. In block 4910, time stamps of system-indicator values located within the upper and/or lower confidence bounds are labeled as normal, as described above with reference FIG. 36C.

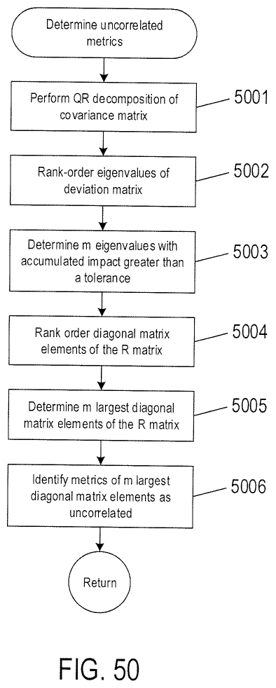

FIG. 50 is a flow diagram of an example implementation of the “determine uncorrelated metrics” step referred to in block 4305 of FIG. 43. In block 5001, QR decomposition is performed on the deviation matrix computed in block 4503 of FIG. 45, as described above with reference to FIG. 37. In block 5002, the eigenvalues computed in block 4504 of FIG. 45 are rank ordered. In block 5003, m of the rank-ordered eigenvalues with an accumulated impact that satisfies Equations (34a) and (34b) are determined. In block 5004, diagonal matrix elements of the R matrix determined in block 5001 are rank order. In block 5005, the m largest diagonal matrix elements of the R matrix are determined as described above with reference to Equation (35d). In block 5006, the metrics of the m largest diagonal matrix elements of the R matrix are identified as uncorrelated, as described above with reference to Equation (36).

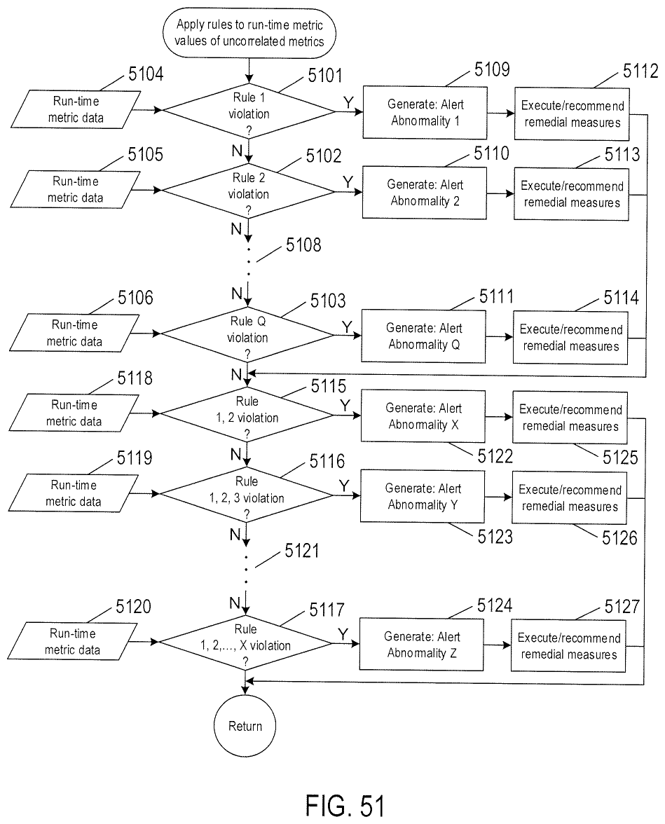

FIG. 51 is a flow diagram of an example implementation of the “apply rules to run-time metric values of uncorrelated metrics” step referred to in block 4307 of FIG. 43. In decision blocks, 5101, 5101, and 5103 rules are applied to run-time metric data 5104, 5105, and 5106, respectively. Ellipsis 5108 represents rules (not shown) applied to the run-time metric data. When one of the rules represented by decision blocks 5101, 5102, and 5103 are violated, control flows to corresponding blocks 5109, 5110, and 5111, in which a corresponding alert identifying the abnormality associated with the rule violation is generated as described above with reference to FIGS. 21 and 22. In blocks 5112, 5113, and 5114, remedial measures are provided or executed to correct the abnormal behavior of the object. In decision blocks, 5115, 5116, and 5117 combinations of rules are applied to the run-time metric data 5118, 5119, and 5120, respectively. Ellipsis 5121 represents combinations of rules (not shown) associated with combinations of run-time metric data. When one of the rules represented by decision blocks 5115, 5116, and 5117 are violated, control flows to corresponding blocks 5122, 5123, and 5124, in which a corresponding alert identifying the abnormality associated with combinations of rule violations is generated as described above with reference to FIG. 23. In blocks 5125, 5126, and 5127, remedial measures are provided or executed to correct the abnormal behavior of object.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. In a process that detects abnormal behavior of a complex computational system of a distributed computing system from a set metrics associated with the complex computational system, the specific improvement comprising:
determining principal components of the metrics over a historical time window;
determining time stamps of abnormal behavior of the complex computational system within the historical time window based on the principal components;
determining uncorrelated metrics of the metrics;
computing rules that classify abnormal behavior of the complex computational system based on the uncorrelated metrics and the time stamps of abnormal behavior; and
generating an alert that identifies abnormal behavior of the complex computational system when at least one of the rules is violated by run-time metric values of the uncorrelated metrics, thereby enabling identification and correction of the abnormal behavior of the complex computational system.

2. The process of claim 1 further comprising:
deleting constant and nearly constant metrics from the metrics; and
synchronizing the metrics to a general sequence of time stamps.

3. The process of claim 2 wherein deleting the constant and nearly constant metrics in the metrics comprises:
computing a standard deviation for each metric in the metric data; and
deleting each metric with a standard deviation less than a standard deviation threshold.

4. The process of claim 1 wherein applying principal component analysis to the metrics comprises:
for each metric of the metrics
computing a mean of metric values that comprise the metric, and
subtracting the mean from each metric value of the metric to obtain a mean-centered metric;
computing deviation matrix based on the mean-centered metrics;
computing eigenvalues and eigenvectors for the deviation matrix;
computing the principal components of the deviation matrix based on the eigenvalues and eigenvectors; and
identifying the high-variance principal components of the principal components.

5. The process of claim 4 wherein identifying the high-variance principal components of the principal components comprises:
computing a variance for each principal component;
computing a percentage of variance for each subset of principal components, each subset comprising a different number of principal components with the largest corresponding variances;
determining a smallest percentage of variances that is greater than a percentage of variance threshold; and
identifying the principal components that correspond to the smallest percentage of variances as the high-variance principal components.

6. The process of claim 1 wherein determining time stamps of abnormal behavior of the complex computational system over the historical time window based on the principal components comprises:
determining one or more clusters principal-component points based on the principal components, each principal-component point comprising principal-component values with the same time stamp; and
for each cluster
determining outliers of the principal-component points, and
labeling time stamps of the outlier principal-component points as corresponding to abnormal behavior of the complex computational system.

7. The process of claim 1 wherein determining time stamps of abnormal behavior of the complex computational system over the historical time window based on the principal components comprises:
computing a system indicator form the principal components;
computing upper and/or lower normal bounds from system-indicator values of the system indicator; and
labeling time stamps of the system-indicator values that are located outside the upper and/or lower normal bounds.

8. The process of claim 1 wherein determining time stamps of abnormal behavior of the complex computational system over the historical time window based on the principal components comprises:
computing a system indicator form the principal components;
partitioning the historical time window into a historical interval and a forecast interval;
compute a time-series model based on system-indicator values of the system indicator in the historical interval;
using the time-series model to compute forecast system-indicator values in the forecast interval;
computing upper and/or lower confidence bounds over the forecast interval based on the time-series model;
labeling time stamps of the system-indicator values in the forecast interval that are located outside the upper and/or lower normal bounds.

9. The process of claim 1 wherein determining uncorrelated metrics of the metrics comprises:
for each metric of the metrics
computing a mean of metric values that comprise the metric, and
subtracting the mean from each metric value of the metric to obtain a mean-centered metric;
computing deviation matrix based on the mean-centered metrics;
computing eigenvalues for the deviation matrix;
rank order the eigenvalues from largest to smallest;
determining eigenvalues with a largest accumulated impact;
decomposing the deviation matrix into a Q matrix and an upper-diagonal R matrix;
determining diagonal elements of the R matrix based on the eigenvalues with the largest accumulated impact; and
identifying metrics that correspond to the diagonal elements as the uncorrelated metrics.

10. The process of claim 1 further comprising executing remedial measures in response to the alert and the identified abnormal behavior of the complex computational system.

11. A computer system to detect abnormal behavior of a complex computational system of a distributed computing system, the system comprising:
one or more processors;
one or more data-storage devices; and
machine-readable instructions stored in the one or more data-storage devices that when executed using the one or more processors controls the system to execute operations comprising:
determining principal components of metrics over a historical time window, the metrics associated with the complex computational system;
determining time stamps of abnormal behavior of the complex computational system within the historical time window based on the principal components;
determining uncorrelated metrics of the metrics;
computing rules that classify abnormal behavior of the complex computational system based on the uncorrelated metrics and the time stamps of abnormal behavior; and
generating an alert that identifies abnormal behavior of the complex computational system when at least one of the rules is violated by run-time metric values of the uncorrelated metrics, thereby enabling identification and correction of the abnormal behavior of the complex computational system.

12. The computer system of claim 11 further comprising:
deleting constant and nearly constant metrics from the metrics; and
synchronizing the metrics to a general sequence of time stamps.

13. The computer system of claim 12 wherein deleting the constant and nearly constant metrics in the metrics comprises:
computing a standard deviation for each metric in the metric data; and
deleting each metric with a standard deviation less than a standard deviation threshold.

14. The computer system of claim 11 wherein applying principal component analysis to the metrics comprises:
for each metric of the metrics
computing a mean of metric values that comprise the metric, and
subtracting the mean from each metric value of the metric to obtain a mean-centered metric;
computing deviation matrix based on the mean-centered metrics;
computing eigenvalues and eigenvectors for the deviation matrix;
computing the principal components of the deviation matrix based on the eigenvalues and eigenvectors; and
identifying the high-variance principal components of the principal components.

15. The computer system of claim 14 wherein identifying the high-variance principal components of the principal components comprises:
computing a variance for each principal component;
computing a percentage of variance for each subset of principal components, each subset comprising a different number of principal components with the largest corresponding variances;
determining a smallest percentage of variances that is greater than a percentage of variance threshold; and
identifying the principal components that correspond to the smallest percentage of variances as the high-variance principal components.

16. The computer system of claim 11 wherein determining time stamps of abnormal behavior of the complex computational system over the historical time window based on the principal components comprises:
determining one or more clusters principal-component points based on the principal components, each principal-component point comprising principal-component values with the same time stamp; and
for each cluster
determining outliers of the principal-component points, and
labeling time stamps of the outlier principal-component points as corresponding to abnormal behavior of the complex computational system.

17. The computer system of claim 11 wherein determining time stamps of abnormal behavior of the complex computational system over the historical time window based on the principal components comprises:
computing a system indicator form the principal components;
computing upper and/or lower normal bounds from system-indicator values of the system indicator; and
labeling time stamps of the system-indicator values that are located outside the upper and/or lower normal bounds.

18. The computer system of claim 11 wherein determining time stamps of abnormal behavior of the complex computational system over the historical time window based on the principal components comprises:
computing a system indicator form the principal components;
partitioning the historical time window into a historical interval and a forecast interval;
compute a time-series model based on system-indicator values of the system indicator in the historical interval;
using the time-series model to compute forecast system-indicator values in the forecast interval;
computing upper and/or lower confidence bounds over the forecast interval based on the time-series model;
labeling time stamps of the system-indicator values in the forecast interval that are located outside the upper and/or lower normal bounds.

19. The computer system of claim 11 wherein determining uncorrelated metrics of the metrics comprises:
for each metric of the metrics
computing a mean of metric values that comprise the metric, and
subtracting the mean from each metric value of the metric to obtain a mean-centered metric;
computing deviation matrix based on the mean-centered metrics;
computing eigenvalues for the deviation matrix;
rank order the eigenvalues from largest to smallest;
determining eigenvalues with a largest accumulated impact;
decomposing the deviation matrix into a Q matrix and an upper-diagonal R matrix;
determining diagonal elements of the R matrix based on the eigenvalues with the largest accumulated impact; and
identifying metrics that correspond to the diagonal elements as the uncorrelated metrics.

20. The computer system of claim 11 further comprising executing remedial measures in response to the alert and the identified abnormal behavior of the complex computational system.

21. A non-transitory computer-readable medium encoded with machine-readable instructions that implement a method carried out by one or more processors of a computer system to execute operations comprising:
determining principal components of metrics over a historical time window, the metric associated with a complex computational system of a distributed computing system;
determining time stamps of abnormal behavior of the complex computational system within the historical time window based on the principal components;
determining uncorrelated metrics of the metrics;
computing rules that classify abnormal behavior of the complex computational system based on the uncorrelated metrics and the time stamps of abnormal behavior; and
generating an alert that identifies abnormal behavior of the complex computational system when at least one of the rules is violated by run-time metric values of the uncorrelated metrics, thereby enabling identification and correction of the abnormal behavior of the complex computational system.

22. The medium of claim 21 further comprising:
deleting constant and nearly constant metrics from the metrics; and
synchronizing the metrics to a general sequence of time stamps.

23. The medium of claim 22 wherein deleting the constant and nearly constant metrics in the metrics comprises:
computing a standard deviation for each metric in the metric data; and
deleting each metric with a standard deviation less than a standard deviation threshold.

24. The medium of claim 21 wherein applying principal component analysis to the metrics comprises:
for each metric of the metrics
computing a mean of metric values that comprise the metric, and
subtracting the mean from each metric value of the metric to obtain a mean-centered metric;
computing deviation matrix based on the mean-centered metrics;
computing eigenvalues and eigenvectors for the deviation matrix;
computing the principal components of the deviation matrix based on the eigenvalues and eigenvectors; and
identifying the high-variance principal components of the principal components.

25. The medium of claim 24 wherein identifying the high-variance principal components of the principal components comprises:
computing a variance for each principal component;
computing a percentage of variance for each subset of principal components, each subset comprising a different number of principal components with the largest corresponding variances;
determining a smallest percentage of variances that is greater than a percentage of variance threshold; and
identifying the principal components that correspond to the smallest percentage of variances as the high-variance principal components.

26. The medium of claim 21 wherein determining time stamps of abnormal behavior of the complex computational system over the historical time window based on the principal components comprises:
determining one or more clusters principal-component points based on the principal components, each principal-component point comprising principal-component values with the same time stamp; and
for each cluster
determining outliers of the principal-component points, and
labeling time stamps of the outlier principal-component points as corresponding to abnormal behavior of the complex computational system.

27. The medium of claim 21 wherein determining time stamps of abnormal behavior of the complex computational system over the historical time window based on the principal components comprises:
computing a system indicator form the principal components;
computing upper and/or lower normal bounds from system-indicator values of the system indicator; and
labeling time stamps of the system-indicator values that are located outside the upper and/or lower normal bounds.

28. The medium of claim 21 wherein determining time stamps of abnormal behavior of the complex computational system over the historical time window based on the principal components comprises:
computing a system indicator form the principal components;
partitioning the historical time window into a historical interval and a forecast interval;
compute a time-series model based on system-indicator values of the system indicator in the historical interval;
using the time-series model to compute forecast system-indicator values in the forecast interval;
computing upper and/or lower confidence bounds over the forecast interval based on the time-series model;
labeling time stamps of the system-indicator values in the forecast interval that are located outside the upper and/or lower normal bounds.

29. The medium of claim 21 wherein determining uncorrelated metrics of the metrics comprises:
for each metric of the metrics
computing a mean of metric values that comprise the metric, and
subtracting the mean from each metric value of the metric to obtain a mean-centered metric;
computing deviation matrix based on the mean-centered metrics;
computing eigenvalues for the deviation matrix;
rank order the eigenvalues from largest to smallest;
determining eigenvalues with a largest accumulated impact;
decomposing the deviation matrix into a Q matrix and an upper-diagonal R matrix;
determining diagonal elements of the R matrix based on the eigenvalues with the largest accumulated impact; and
identifying metrics that correspond to the diagonal elements as the uncorrelated metrics.

30. The medium of claim 21 further comprising executing remedial measures in response to the alert and the identified abnormal behavior of the complex computational system.
